(19) United States
(12) Patent Application Publication
(10) Pub. No.: US 2023/0168098 A1
(43) Pub. Date: Jun. 1, 2023

(54) TRAVELING PLAN PREPARATION APPARATUS AND TRAVELING PLAN PREPARATION METHOD

(71) Applicant: Mitsubishi Electric Corporation, Tokyo (JP)

(72) Inventors: Yoshinori UENO, Tokyo (JP); Mitsuo SHIMOTANI, Tokyo (JP); Yusuke ARAI, Tokyo (JP)

(73) Assignee: Mitsubishi Electric Corporation, Tokyo (JP)

(21) Appl. No.: 17/920,173

(22) PCT Filed: Jul. 1, 2020
(86) PCT No.: PCT/JP2020/025748

§ 371 Date: Oct. 20, 2022

(51) Int. Cl. G01C 21/34; G01C 21/36; B60W 60/00

(52) U.S. Cl. CPC G01C 21/3492; G01C 21/3685; B60W 60/001; B60W 2554/406

(57) ABSTRACT

An object is to provide a technique allowing reduction in the occurrence of a traffic jam to be caused by autonomous driving by an autonomous driving vehicle. A traveling plan preparation apparatus includes a traveling plan preparation unit that prepares an autonomous driving traveling plan on the basis of traveling cost including convenience cost. The traveling plan preparation unit increases the convenience cost as a congestion level becomes higher, and performs at least one of a process of increasing the convenience cost with a smaller margin of time and a process of reducing the convenience cost with greater closeness of a road to a pick-up position.

### TECHNICAL FIELD

The present disclosure relates to a traveling plan preparation apparatus and a traveling plan preparation method.

### BACKGROUND ART

In a conventional case, for going to a shopping plaza and enjoying shopping for a while, a user such as a driver is to drive a vehicle and park the vehicle by himself or herself in a parking lot near the shopping plaza and to pay a parking fee. Meanwhile, according to a technique suggested by Patent Document 1 relating to a vehicle to control driving (control traveling) autonomously even in the absence of a driver, namely, relating to an autonomous driving vehicle configured to do autonomous driving, control is exerted to move the autonomous driving vehicle to a predetermined place after passage of a predetermined amount of time.

### PRIOR ART DOCUMENTS

### Patent Documents

Patent Document 1: Japanese Patent Application Laid-Open No. 2018-067172

### SUMMARY

### Problem to be Solved by the Invention

By using a technique such as that in Patent Document 1, making an autonomous driving vehicle drive autonomously on a public road until a scheduled finish time for shopping is considered to allow a user to enjoy shopping at lower cost than a parking fee. However, making the autonomous driving vehicle drive autonomously on a road around a place where vehicles generally pass frequently such as a road around a shopping mall increases a congestion level (volume of traffic) on the road, causing a risk of the occurrence of a traffic jam.

The present disclosure has been made in view of the above-described problem, and is intended to provide a technique allowing reduction in the occurrence of a traffic jam to be caused by autonomous driving by an autonomous driving vehicle.

### Means to Solve the Problem

A traveling plan preparation apparatus according to the present disclosure is a traveling plan preparation apparatus that prepares an autonomous driving traveling plan for an autonomous driving vehicle configured to do autonomous driving using map information and instructs the autonomous driving vehicle to follow the autonomous driving traveling plan. The traveling plan preparation apparatus includes: an acquisition unit that acquires pick-up instruction information including a pick-up time and a pick-up position where the autonomous driving vehicle is to be located on the pick-up time, a congestion level on each of roads classified in advance, and a vehicle position as the position of the autonomous driving vehicle; and a traveling plan preparation unit that determines traveling cost including convenience cost of a traveling route including the road for the autonomous driving vehicle on the basis of the pick-up instruction information, the congestion level, a time and the vehicle position at a moment when the pick-up instruction information is acquired, and the map information, and prepares the autonomous driving traveling plan for the autonomous driving vehicle to arrive at the pick-up position on the pick-up time on the basis of the traveling cost. The traveling plan preparation unit increases the convenience cost of the road as the congestion level on the road becomes higher, and performs at least one of a process of increasing the convenience cost of the road with a smaller margin of time for the autonomous driving vehicle to arrive at the pick-up position from the road by the pick-up time and a process of reducing the convenience cost of the road with greater closeness of the road to the pick-up position.

### Effects of the Invention

According to the present disclosure, at least one of a process of increasing the convenience cost of the road with a smaller margin of time for the autonomous driving vehicle to arrive at the pick-up position from the road by the pick-up time and a process of reducing the convenience cost of the road with greater closeness of the road to the pick-up position is performed. This allows reduction in the occurrence of a traffic jam to be caused by autonomous driving by the autonomous driving vehicle.

These and other objects, features, aspects and advantages of the present disclosure will become more apparent from the following detailed description and the accompanying drawings.

### BRIEF DESCRIPTION OF DRAWINGS

FIG. 1 is a block diagram showing the configuration of a traveling plan preparation apparatus according to a first embodiment;

FIG. 2 is a block diagram showing the configuration of a traveling plan preparation apparatus according to a second embodiment;

FIG. 3 is a flowchart showing operation by the traveling plan preparation apparatus according to the second embodiment;

FIG. 4 is a view for explaining exemplary operation by the traveling plan preparation apparatus according to the second embodiment;

FIG. 5 is a view for explaining a factor according to the second embodiment;

FIG. 6 is a view for explaining a factor according to the second embodiment;

FIG. 7 is a block diagram showing the configuration of a traveling plan preparation apparatus according to a second modification of the second embodiment;

FIG. 8 is a view for explaining a factor according to a third modification of the second embodiment;

FIG. 9 is a view for explaining a factor according to a fourth modification of the second embodiment;

FIG. 10 is a block diagram showing the configuration of a traveling plan preparation apparatus according to a third embodiment;

FIG. 11 is a flowchart showing operation by the traveling plan preparation apparatus according to the third embodiment;

FIG. 12 is a flowchart showing the operation by the traveling plan preparation apparatus according to the third embodiment;

FIG. 13 is a view for explaining fuel cost and parking fee cost according to the third embodiment;

FIG. 14 is a block diagram showing the configuration of a traveling plan preparation apparatus according to a fourth embodiment;

FIG. 15 is a block diagram showing the configuration of a traveling plan preparation apparatus according to a first modification of the fourth embodiment;

FIG. 16 is a block diagram showing the configuration of a traveling plan preparation apparatus according to a third modification of the fourth embodiment;

FIG. 17 is a block diagram showing the hardware configuration of a traveling plan preparation apparatus according to a different modification;

FIG. 18 is a block diagram showing the hardware configuration of the traveling plan preparation apparatus according to a different modification; and

FIG. 19 is a block diagram showing the configuration of a communication terminal according to a different modification.

### DESCRIPTION OF EMBODIMENT(S)

### First Embodiment

A traveling plan preparation apparatus according to a first embodiment prepares an autonomous driving traveling plan for an autonomous driving vehicle configured to do autonomous driving using map information, and instructs the autonomous driving vehicle to follow the autonomous driving traveling plan. In the following, the autonomous driving vehicle equipped with the traveling plan preparation apparatus and to be focused as a target will also be called an “subject vehicle.” As will be described later, the traveling plan preparation apparatus is not required to be installed on the subject vehicle. The map information used for the preparation of the autonomous driving traveling plan may be stored in advance in the traveling plan preparation apparatus or may be acquired from outside of the traveling plan preparation apparatus, if appropriate.

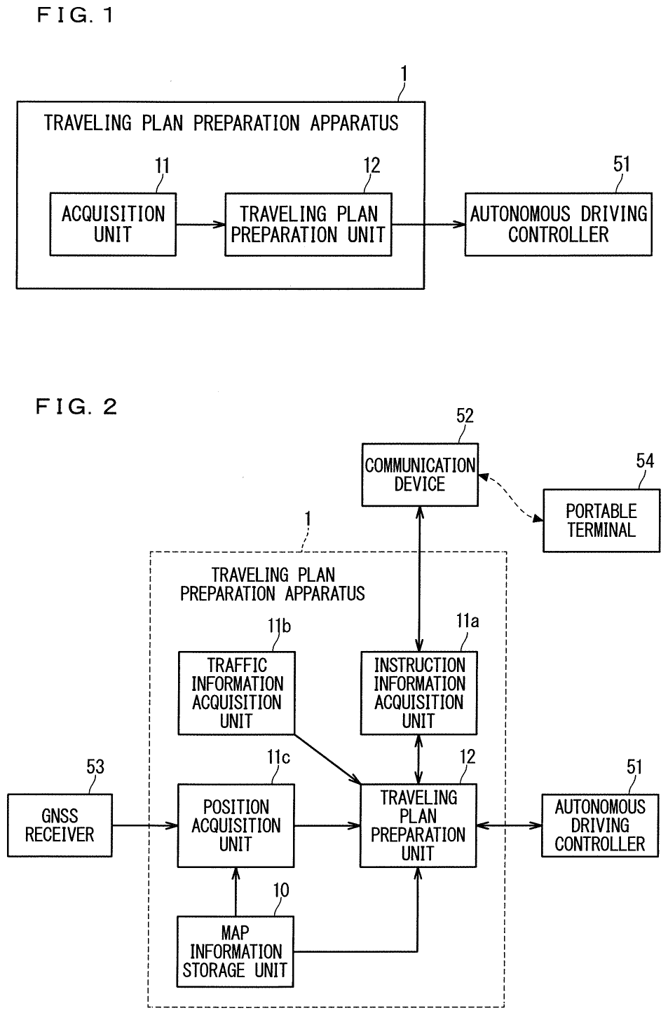

FIG. 1 is a block diagram showing the configuration of a traveling plan preparation apparatus 1 according to the first embodiment. The traveling plan preparation apparatus 1 in FIG. 1 is communicably connected to an autonomous driving controller 51 without or with wires.

The autonomous driving controller 51 controls autonomous driving by the subject vehicle on the basis of the autonomous driving traveling plan prepared by the traveling plan preparation apparatus 1, thereby controlling traveling by the subject vehicle.

The traveling plan preparation apparatus 1 in FIG. 1 includes an acquisition unit 11 and a traveling plan preparation unit 12.

The acquisition unit 11 acquires pick-up instruction information including a pick-up time and a pick-up position where the subject vehicle is to be located on the pick-up time. This function of the acquisition unit 11 is fulfilled by using at least one of a touch panel for accepting operation of setting pick-up instruction information by a user such as a driver, a gesture operation detector, an audio input device, a communication device for receiving the operation from a portable terminal having accepted the operation, and interfaces for these devices, for example.

The acquisition unit 11 acquires a congestion level on each road classified in advance. The road classified in advance corresponds to a road link included in the map information, for example. This function of the acquisition unit 11 is fulfilled by using at least one of a communication device for receiving a congestion level from a vehicle information and communication system (VICS) (registered trademark) or a traffic information center, an arithmetic device for calculating a congestion level on the basis of various types of information, and interfaces for these devices, for example.

The acquisition unit 11 acquires a vehicle position as the position of the subject vehicle. This function of the acquisition unit 11 is fulfilled by using at least one of a global navigation satellite system (GNSS) receiver such as a global positioning system (GPS) receiver and an interface for this GNSS receiver, for example.

The traveling plan preparation unit 12 determines traveling cost including convenience cost of a traveling route for the subject vehicle, including a road on the basis of the pick-up instruction information (a pick-up time and a pick-up position), a congestion level, a time and a vehicle position at a moment when the pick-up instruction information is acquired, and the map information. In the following description, the time corresponding to the moment when the acquisition unit 11 acquires the pick-up instruction information may also be called an “acquisition time,” and the vehicle position at a moment when the acquisition unit 11 acquires the pick-up instruction information may also be called an “acquisition vehicle position.”

To simplify the description, in an exemplary case given herein, traveling cost is convenience cost of a traveling route. First, the traveling plan preparation unit 12 determines a difference between a pick-up time and an acquisition time as an interval period. Then, the traveling plan preparation unit 12 comprehensively determines a traveling route from the map information along which an amount of time required for the subject vehicle to travel from an acquisition vehicle position to a pick-up position becomes equal to or less than the determined interval period or becomes substantially equal to the interval period. This traveling route may be determined through route search conducted by using a general navigation device, for example, or may be determined through numerical calculation of calculating an optimum value or a minimum value, for example.

Regarding a road included in the traveling route, the traveling plan preparation unit 12 determines convenience cost of the road on the basis of a congestion level on the road, the interval period, the acquisition vehicle position, the position of the road, and the pick-up position. Here, the traveling plan preparation unit 12 increases convenience cost of the road as a congestion level on this road becomes higher. Furthermore, the traveling plan preparation unit 12 performs at least one of a process of increasing convenience cost of the road with a smaller margin of time for the subject vehicle to arrive at the pick-up position from this road by the pick-up time and a process of reducing convenience cost of the road with greater closeness of this road to the pick-up position.

The margin of time is substantially equal to an amount of allowed time indicating an amount of time obtained by subtracting an amount of time required for the subject vehicle to arrive at a road from the acquisition vehicle position and an amount of time required for the subject vehicle to arrive at the pick-up position from the road from the interval period. If an amount of allowed time of the road is small, for example, a margin of time of the road is reduced to increase convenience cost of the road. An amount of time required for the subject vehicle to arrive at the road from the acquisition vehicle position and an amount of time required for the subject vehicle to arrive at the pick-up position from the road, which are required for calculation of an amount of allowed time, may be obtained through prediction of an arrival time using a general navigation device, for example.

A small margin of time (amount of allowed time) for arrival from the road to the pick-up position by the pick-up time is substantially equal to a great distance of the road from the pick-up position except for some exceptions. Thus, increasing convenience cost of the road with a smaller margin of time for arrival from this road to the pick-up position by the pick-up time is substantially equal to reducing convenience cost of the road with greater closeness of this road to the pick-up position.

Next, the traveling plan preparation unit 12 determines a sum of convenience costs of roads included in the traveling route as convenience cost of the traveling route, and uses the determined convenience cost of the traveling route as traveling cost. The traveling cost determined in this way is likely to become high if a congestion level on the road included in the traveling route is high, and is likely to become high if a margin of time of the road included in the traveling route is small.

On the basis of the determined traveling cost, the traveling plan preparation unit 12 prepares an autonomous driving traveling plan for the subject vehicle to arrive at the pick-up position on the pick-up time. For example, the traveling plan preparation unit 12 prepares an autonomous driving traveling plan for causing the subject vehicle to travel along a traveling route of the lowest traveling cost. As another example, the traveling plan preparation unit 12 prepares an autonomous driving traveling plan for causing the subject vehicle to travel along a traveling route designated by a user from traveling routes whose traveling costs are equal to or less than a threshold defined in advance. The autonomous driving traveling plan may be expressed by a scheduled position where the subject vehicle is to be located at each time or may be expressed by a scheduled speed to be employed as a speed of the subject vehicle along each road link.

The autonomous driving traveling plan prepared by the traveling plan preparation unit 12 is output to the autonomous driving controller 51. The autonomous driving controller 51 controls autonomous driving by the subject vehicle on the basis of the output autonomous driving traveling plan.

<Conclusion of First Embodiment>

The traveling plan preparation apparatus 1 according to the first embodiment described above determines traveling cost on the basis of pick-up instruction information, a congestion level, a time and a vehicle position at a moment when the pick-up instruction information is acquired, and map information, and prepares an autonomous driving traveling plan on the basis of the determined traveling cost. Not only the congestion level on a road but also at least one of a margin of time and a distance to a pick-up position of the road is reflected in the traveling cost. This configuration makes it possible to prepare an autonomous driving traveling plan for causing the subject vehicle to travel on a road of greatest possible closeness to the pick-up position while reducing the occurrence of a traffic jam.

### Second Embodiment

FIG. 2 is a block diagram showing the configuration of a traveling plan preparation apparatus 1 according to a second embodiment. Of constituting elements of the second embodiment, constituting elements same as or similar to those described above are given the same or similar reference signs, and different constituting elements will mainly be described.

The traveling plan preparation apparatus 1 in FIG. 2 is communicably connected to an autonomous driving controller 51, a communication device 52, and a GNSS receiver 53 without or with wires. The autonomous driving controller 51 is the same as the autonomous driving controller 51 described in the first embodiment.

A portable terminal 54 of a user accepts pick-up instruction information (a pick-up time and a pick-up position) at a moment when the user gets out of a subject vehicle. The communication device 52 communicates with the portable terminal 54 to receive the pick-up instruction information accepted from the user. The communication device 52 forms the communication using a public communication line, a wireless local area network (LAN), or a ultra wideband (UWB), for example.

The GNSS receiver 53 measures a vehicle position of the subject vehicle by satellite positioning.

The configuration of the traveling plan preparation apparatus 1 in FIG. 2 will be described next. The traveling plan preparation apparatus 1 in FIG. 2 includes a map information storage unit 10, an instruction information acquisition unit 11a, a traffic information acquisition unit 11b, a position acquisition unit 11c, and a traveling plan preparation unit 12. The instruction information acquisition unit 11a, the traffic information acquisition unit 11b, and the position acquisition unit 11c in FIG. 2 are included in the concept of the acquisition unit 11 in FIG. 1.

The map information storage unit 10 stores map information used in preparation of an autonomous driving traveling plan by the traveling plan preparation unit 12. The map information includes each road classified in advance such as a road link such as an amount of time required for the subject vehicle to travel on a road and the length of a road, for example.

The instruction information acquisition unit 11a acquires the pick-up instruction information accepted by the portable terminal 54 and received by the communication device 52. With the above-described configuration, the instruction information acquisition unit 11a according to the second embodiment acquires the pick-up instruction information when the user gets off the subject vehicle.

The traffic information acquisition unit 11b acquires a congestion level on each road in an area where the subject vehicle is located from VICS (registered trademark), a traffic information center, or the map information, for example.

The position acquisition unit 11c acquires the vehicle position measured by the GNSS receiver 53. The position acquisition unit 11c may acquire the vehicle position on the basis of the vehicle position measured by the GNSS receiver 53, and a vehicle speed pulse of the subject vehicle and vehicle information detected by an acceleration sensor not shown in the drawings, for example. The position acquisition unit 11c may perform map matching of the vehicle position on the basis of the map information stored in the map information storage unit 10 and a traveling path of the subject vehicle in the past.

The traveling plan preparation unit 12 has the same function as the traveling plan preparation unit 12 described in the first embodiment. Specifically, the traveling plan preparation unit 12 determines traveling cost including convenience cost of a traveling route on the basis of the pick-up instruction information (a pick-up time and a pick-up position), a congestion level, an acquisition time and an acquisition vehicle position (a time and a vehicle position at a moment when the pick-up instruction information is acquired), and the map information.

The traveling plan preparation unit 12 increases convenience cost of a road as a congestion level on the road becomes higher. Furthermore, in the second embodiment, with a smaller margin of time for arrival at the pick-up position from the road by the pick-up time, the traveling plan preparation unit 12 increases convenience cost of this road. On the basis of the determined traveling cost, the traveling plan preparation unit 12 prepares an autonomous driving traveling plan for the subject vehicle to arrive at the pick-up position on the pick-up time.

The autonomous driving traveling plan prepared by the traveling plan preparation unit 12 is output to the autonomous driving controller 51. The autonomous driving controller 51 controls autonomous driving by the subject vehicle on the basis of the output autonomous driving traveling plan.

In the second embodiment, the traveling plan preparation unit 12 prepares an autonomous driving traveling plan for the subject vehicle to travel through a position farther from respect the pick-up position than the acquisition vehicle position in a period from the acquisition time to the pick-up time. As a result of this configuration, an autonomous driving traveling plan to be prepared is not for the subject vehicle to travel along the shortest route between the acquisition vehicle position and the pick-up position but for the subject vehicle to travel along a detour route between these positions in the period from the acquisition time to the pick-up time. Here, while the description proceeds on the assumption that the acquisition vehicle position is the same as the pick-up position, the acquisition vehicle position may be different from the pick-up position.

<Operation>

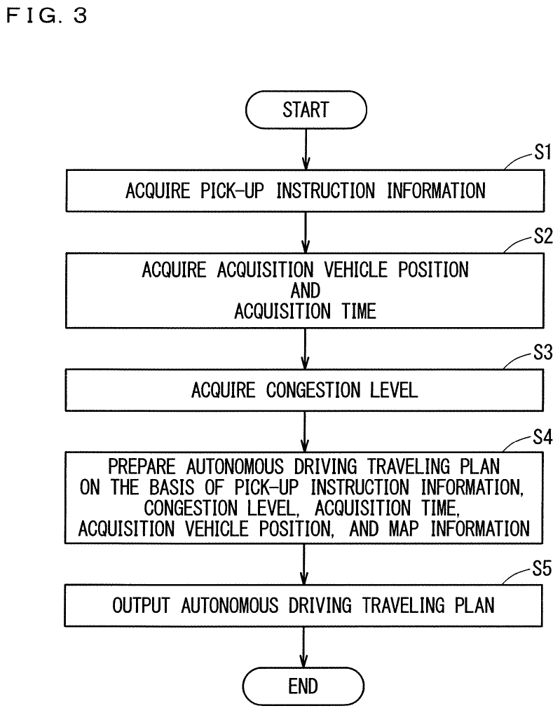

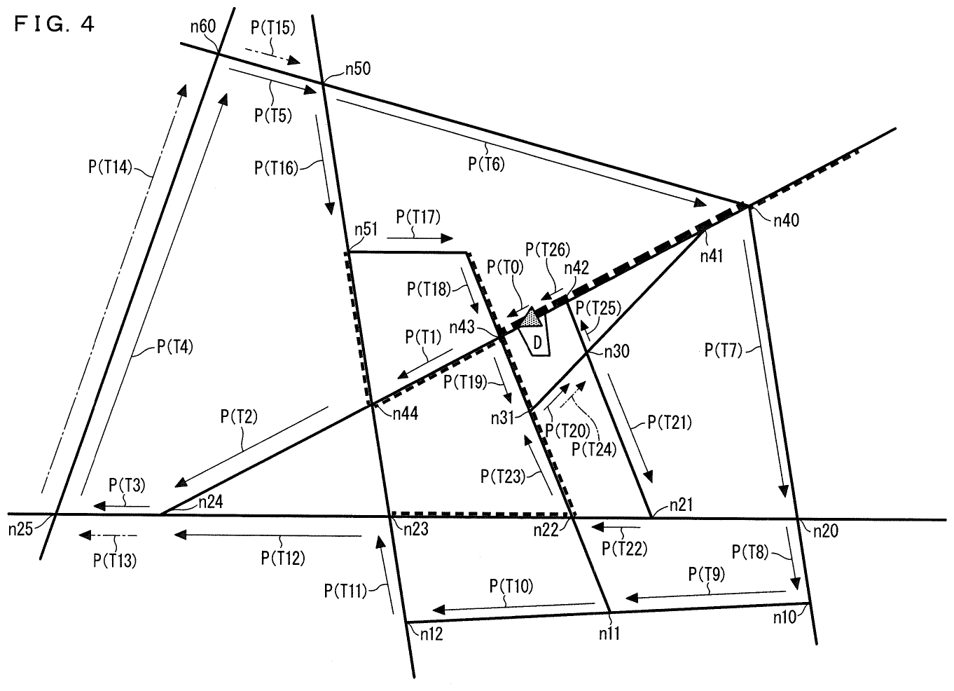

FIG. 3 is a flowchart showing operation by the traveling plan preparation apparatus 1 according to the second embodiment. FIG. 4 shows an example of the operation. FIG. 4 shows nodes n1 to n12, n20 to n25, n30, n31, n40 to n44, n50, n51, and n60, and a road link corresponds to a line between the nodes.

First, in step S1 in FIG. 3, the instruction information acquisition unit 11a acquires an instruction to execute an autonomous driving mode from a user getting out of the subject vehicle through the portable terminal 54 and the communication device 52 and acquires pick-up instruction information. In the example in FIG. 4, a pick-up position corresponds to a shopping plaza D including a position that can substantially be regarded as the position of the shopping plaza, and a pick-up time is T_{pick-up}. A message urging the user to input the pick-up instruction information may be displayed on the portable terminal 54 when the user gets out of the subject vehicle.

In step S2, the position acquisition unit 11c acquires a vehicle position of the subject vehicle at a moment when the pick-up instruction information is acquired as an acquisition vehicle position, and acquires a time at a moment when the pick-up instruction information is acquired as an acquisition time. In the example in FIG. 4, the acquisition vehicle position corresponds to the shopping plaza D and the acquisition time is T0.

In step S3, the traffic information acquisition unit 11b acquires a congestion level on each road. In the example in FIG. 4, congestion levels on roads within a range of about 30 km from the shopping plaza D are indicated by respective line types. More specifically, a road on which a maximum speed at which a vehicle can travel is less than ⅓ a speed limit is a road of a high congestion level and is given a bold broken line in FIG. 4. A road on which a maximum speed at which a vehicle can travel is less than ⅔ the speed limit is a road of a middle congestion level and is given a thin broken line in FIG. 4. A road on which a maximum speed at which a vehicle can travel is equal to or greater than ⅔ the speed limit and a road without congestion are roads of low congestion levels and are not given broken lines in FIG. 4.

Here, to simplify the description, congestion levels are classified into three states including high, middle, and low. However, this is not the only case as will be described later. Likewise, to simplify the description here, a congestion level is constant with respect to a time. However, a congestion level may be variable with respect to a time as will be described later.

In step S4, the traveling plan preparation unit 12 prepares an autonomous driving traveling plan for the subject vehicle to arrive at the pick-up position on the pick-up time on the basis of the pick-up instruction information (the pick-up time and the pick-up position), the congestion level, the acquisition time and the acquisition vehicle position, and the map information. In step S4, the traveling plan preparation unit 12 according to the second embodiment performs a cost calculation step of determining traveling cost and a plan preparation step of preparing an autonomous driving traveling plan.

<Cost Calculation Step in Step S4>

In the cost calculation step, the traveling plan preparation unit 12 determines traveling cost on the basis of the pick-up instruction information (the pick-up time and the pick-up position), the congestion level, the acquisition time and the acquisition vehicle position, and the map information.

First, like in the first embodiment, the traveling plan preparation unit 12 determines a difference between the pick-up time and the acquisition time as an interval period. In the example in FIG. 4, the interval period is Tᵢₙₜₑᵣᵥₐₗ (=T_{pick-up}−T0).

Regarding each road included in a traveling route, the traveling plan preparation unit 12 determines convenience cost of the road on the basis of the congestion level on the road, the interval period, a distance between the acquisition vehicle position and the road, and a distance between the road and the pick-up position. In the second embodiment, the traveling plan preparation unit 12 comprehensively determines a traveling route from the map information along which an amount of time required for the subject vehicle to travel from the acquisition vehicle position to the pick-up position becomes equal to or less than the interval period Tᵢₙₜₑᵣᵥₐₗ or becomes substantially equal to the interval period Tᵢₙₜₑᵣᵥₐₗ Then, the traveling plan preparation unit 12 determines traveling cost from the traveling route. Here, the traveling cost is expressed by the following formula (1).

$$\begin{matrix}[ Formula 1 ] & \\ COST = COSTA = {\sum }_{rn} costA ( rn ) = {\sum }_{rn} \{ cost 1 ( rn ) \cdot w 1 ( rn ) \cdot w 2 ( rn ) & ( 1 )\end{matrix}$$

In the formula (1), COST means traveling cost, COSTA means convenience cost of a traveling route, rn means a road included in the traveling route, and costA(rn) means convenience cost of the road rn.

In the formula (1), cost1(rn) means an amount of time required for the subject vehicle to travel on the road rn or the length of the road m, w1(rn) means a weighting factor corresponding to a congestion level on the road m, and w2(rn) means a weighting factor corresponding to a margin of time of the road rn. In the following description, the weighting factor may be called a “factor” simply.

In the second embodiment, the traveling plan preparation unit 12 determines the convenience cost costA(rn) of the road rn using the formula (1). The traveling plan preparation unit 12 determines a sum of convenience costs costA(rn) of the roads m included in the traveling route as convenience cost COSTA of the traveling route, and uses the determined convenience cost COSTA of the traveling route as traveling cost COST.

A way of determining the convenience cost costA(rn) of the road rn will be described here.

First, the traveling plan preparation unit 12 sets a value of the factor w1(rn) on the basis of a congestion level. For example, the traveling plan preparation unit 12 sets W13 as the factor w1(rn) if a congestion level is high, sets W12 as the factor w1(rn) if a congestion level is middle, and sets W11 as the factor w1(rn) if a congestion level is low. Here, while the description proceeds on the assumption that W13=3, W12=2, and W11=1, W13, W12, and W11 may be of optional values as long as W13>W12>W11 is satisfied.

Next, the traveling plan preparation unit 12 determines an amount of allowed time on the basis of the interval period Tᵢₙₜₑᵣᵥₐₗ, a distance between the acquisition vehicle position and the road rn, and a distance between the road rn and the pick-up position. The amount of allowed time is an amount of time T_{margin} (=Tᵢₙₜₑᵣᵥₐₗ−Tₐᵣᵣᵢᵥₑ₁−Tₐᵣᵣᵢᵥₑ₂) obtained by subtracting an amount of time Tₐᵣᵣᵢᵥₑ₁ required for the subject vehicle to arrive at the road from the acquisition vehicle position and an amount of time Tₐᵣᵣᵢᵥₑ₂ required for the subject vehicle to arrive at the pick-up position from the road from the interval period Tᵢₙₜₑᵣᵥₐₗ. In the second embodiment, the margin of time is also substantially equal to this amount of allowed time.

The traveling plan preparation unit 12 sets a value of the factor w2(rn) on the basis of the determined amount of allowed time T_{margin}. In the second embodiment, an example of this setting, the traveling plan preparation unit 12 sets a value of the factor w2(rn) using a function of the road rn and the amount of allowed time T_{margin}.

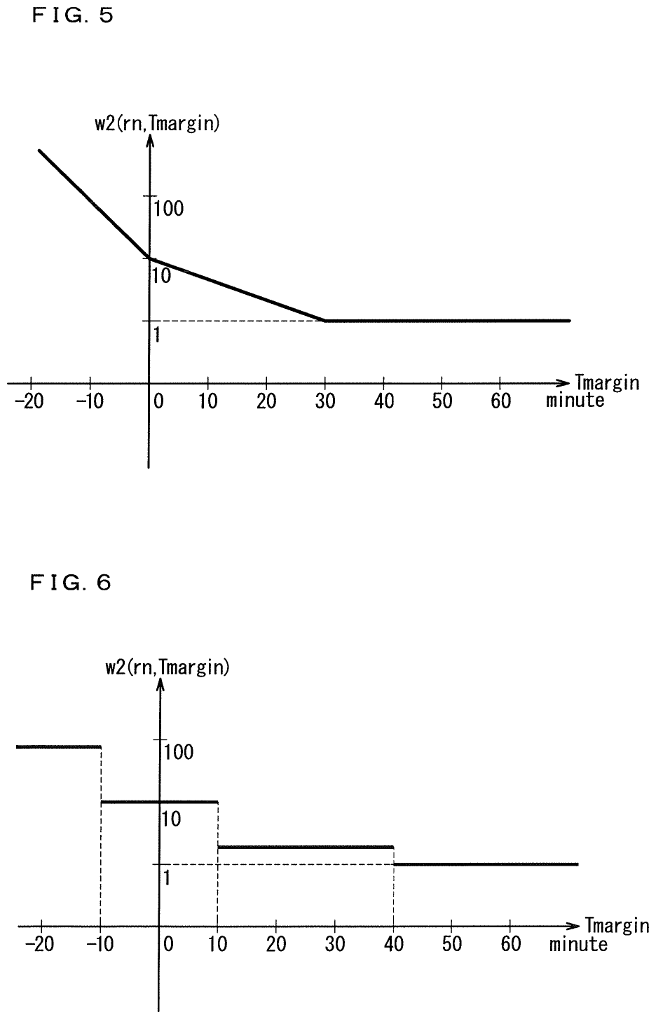

FIGS. 5 and 6 each show an example of the factor w2(rn) expressed as a function of the road m and the amount of allowed time T_{margin}. In FIGS. 5 and 6, to clearly show that the factor w2(rn) is a function of the road rn and the amount of allowed time T_{margin}, the factor w2(rn) is expressed as w2(rn, T_{margin}).

The factor w2(rn) in FIG. 5 is expressed by a continuous function by which, as the amount of allowed time T_{margin} is reduced from 30 minutes, a value of this factor increases continuously from 1 and a rate of this increase is increased stepwise. The factor w2(rn) in FIG. 6 is expressed by a discontinuous function such as a step function by which, as the amount of allowed time T_{margin} is reduced from 40 minutes, a value of this factor increases intermittently from 1 and a rate of this increase is increased stepwise.

The traveling plan preparation unit 12 determines the convenience cost costA(rn) of the road rn by setting values of cost1(rn), the factor w1(rn), and the factor w2(rn) in the formula (1). Then, the traveling plan preparation unit 12 determines a sum of the convenience costs costA(rn) of the roads rn included in the traveling route as the convenience cost COSTA of the traveling route, and uses the determined convenience cost COSTA of the traveling route as the traveling cost COST.

<Plan Preparation Step in Step S4>

In the plan preparation step, the traveling plan preparation unit 12 prepares an autonomous driving traveling plan for the subject vehicle to arrive at the pick-up position on the pick-up time on the basis of the determined traveling cost COST. For example, the traveling plan preparation unit 12 prepares an autonomous driving traveling plan for the subject vehicle to travel along a traveling route of the lowest traveling cost COST.

As a result of the foregoing, if a congestion level on a road is high, a value of the factor w1(rn) is increased to also increase the traveling cost COST in the formula (1). This reduces a likelihood of preparation of an autonomous driving traveling plan for causing the subject vehicle to travel on a road of a high congestion level. Furthermore, if a margin of time (amount of allowed time T_{margin}) is small, a value of the factor w2(rn) is increased to also increase the traveling cost COST in the formula (1). This reduces a likelihood of preparation of an autonomous driving traveling plan for causing the subject vehicle to travel on a road of a small margin of time.

Even if two traveling routes have the same distance, the number of the roads rn along one of the traveling routes and the number of the roads rn along the other traveling route may differ from each other in a manner that depends on the classification of the roads rn. In this case, determining a sum about the roads rn using a way such as the formula (1) causes influence on a value of traveling cost by the difference in the number of the roads rn. To make correction in response to such influence, cost1(rn) indicating an amount of time required for the subject vehicle to travel on the road rn or indicating the length of the road rn is used for the convenience cost costA(rn) of the road rn in the formula (1).

Tendency of the autonomous driving traveling plan prepared in step S4 will be described next. Arrows from P(T0) to P(T26) in FIG. 4 show roads included in the traveling route in the autonomous driving traveling plan. More specifically, these arrows show that the subject vehicle is to travel on roads in the order from the arrow P(T0) to the arrow P(T26). Of these arrows from P(T0) to P(T26), roads on which the subject vehicle is scheduled to travel for the first time are given arrows with solid lines, and roads on which the subject vehicle is schedule to travel for the second time are given arrows with alternate long and short dashed lines. To simplify the description, cost1(rn) in the formula (1) is not considered in FIG. 4.

As described above, an autonomous driving traveling plan prepared in the second embodiment is for causing the subject vehicle to travel along a detour route between the acquisition vehicle position D and the pick-up position D as indicated by the arrows from P(T0) to P(T26) in FIG. 4 in a period from the acquisition time T0 to the pick-up time T_{pick-up}. Thus, even if the acquisition vehicle position D is the same as the pick-up position D, preparation of an autonomous driving traveling plan is prevented that is for causing the subject vehicle to stop continuously at the position D in the period from the acquisition time T0 to the pick-up time T_{pick-up}.

As the subject vehicle moves further on the roads in the order from P(T0) to P(T26), a margin of time becomes smaller to gradually increase influence on traveling cost by the factor w2(Rn). Regarding the roads given P(T0) to P(T15), however, influence on traveling cost by the factor w1(Rn) is larger than influence on traveling cost by the factor w2(Rn) to give priority to a congestion level. As a result, in an initial stage of the autonomous driving traveling plan in FIG. 4, a road far from the pick-up position D but of a low congestion level is used.

On the other hand, regarding the roads given P(T16) to P(T26), influence on traveling cost by the factor w2(Rn) is larger than influence on traveling cost by the factor w1(Rn) to give priority to a margin of time. As a result, in a middle stage and its subsequent stage of the autonomous driving traveling plan in FIG. 4, a road at an intermediate distance from the pick-up position D and of a middle congestion level is used, and then a road of a high congestion level but close to the pick-up position D is used.

After step S4 in FIG. 3, the traveling plan preparation unit 12 outputs the prepared autonomous driving traveling plan to the autonomous driving controller 51 in step S5. By doing so, the autonomous driving traveling plan prepared by the traveling plan preparation unit 12 is output to the autonomous driving controller 51 and the autonomous driving controller 51 controls autonomous driving by the subject vehicle on the basis of the output autonomous driving traveling plan. Then, the operation in FIG. 3 is finished.

<Conclusion of Second Embodiment>

Like in the first embodiment, according to the traveling plan preparation apparatus 1 of the second embodiment described above, not only a congestion level on a road but also at least one of a margin of time and a distance to a pick-up position of the road is reflected in traveling cost. This configuration makes it possible to prepare an autonomous driving traveling plan for causing the subject vehicle to travel on a road of greatest possible closeness to the pick-up position while reducing the occurrence of a traffic jam.

An autonomous driving traveling plan prepared in the second embodiment is for causing the subject vehicle to travel through a position farther from the pick-up position than the acquisition vehicle position in a period from the acquisition time to the pick-up time. This configuration makes it possible to prepare an autonomous driving traveling plan for causing the subject vehicle to travel along a detour route between the acquisition vehicle position and the pick-up position in the period from the acquisition time to the pick-up time.

<First Modification of Second Embodiment>

In the second embodiment, congestion levels are classified into three states including high, middle, and low, and three values (W11, W12, W13) are set as the factor w1(Rn). However, this is not the only case. Congestion levels are only required to be classified into two or more states, and a value to be set as the factor w1(Rn) is only required be one of two or more values. Additionally, each of a congestion level and the factor w1(Rn) may be a continuous value, not a discontinuous value.

<Second Modification of Second Embodiment>

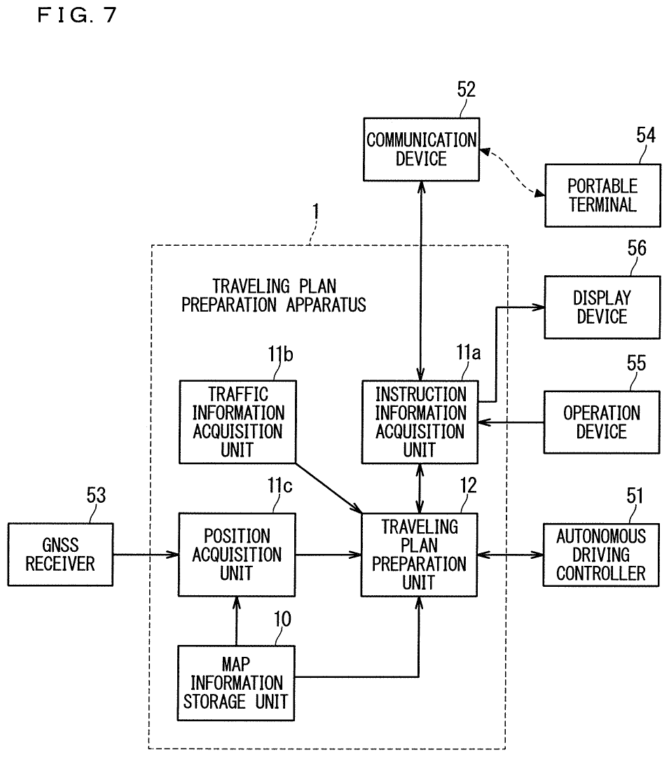

In the second embodiment, the instruction information acquisition unit 11a acquires pick-up instruction information accepted by the portable terminal 54. However, this is not the only case. If the traveling plan preparation apparatus 1 is connected to an operation device 55 provided to the subject vehicle as shown in FIG. 7, for example, the instruction information acquisition unit 11a may acquire pick-up instruction information accepted by the operation device 55. As another example, if the traveling plan preparation apparatus 1 is connected to a display device 56 provided to the subject vehicle as shown in FIG. 7, a map around the subject vehicle, a message for urging a user to input pick-up instruction information, and the accepted pick-up instruction information may be displayed on the display device 56.

<Third Modification of Second Embodiment>

In the second embodiment, the factor w1 (rn) corresponding to a congestion level on the road rn and the factor w2(rn) corresponding to a margin of time of the road rn are used for the convenience cost costA(rn) of the road rn. However, this is not the only case. For example, as shown by the following formula (2), not only the factor w1 (rn) and the factor w2(rn) but also a weighting factor w3(rn) corresponding to closeness of the road m to a pick-up position may be used for the convenience cost costA(rn) of the road m.

$$\begin{matrix}[ Formula 2 ] & \\ COSTA = {\sum }_{rn} costA ( rn ) = {\sum }_{rn} \{ cost 1 ( rn ) \cdot w 1 ( rn ) \cdot w 2 ( rn ) \cdot w 3 ( rn ) \} & ( 2 )\end{matrix}$$

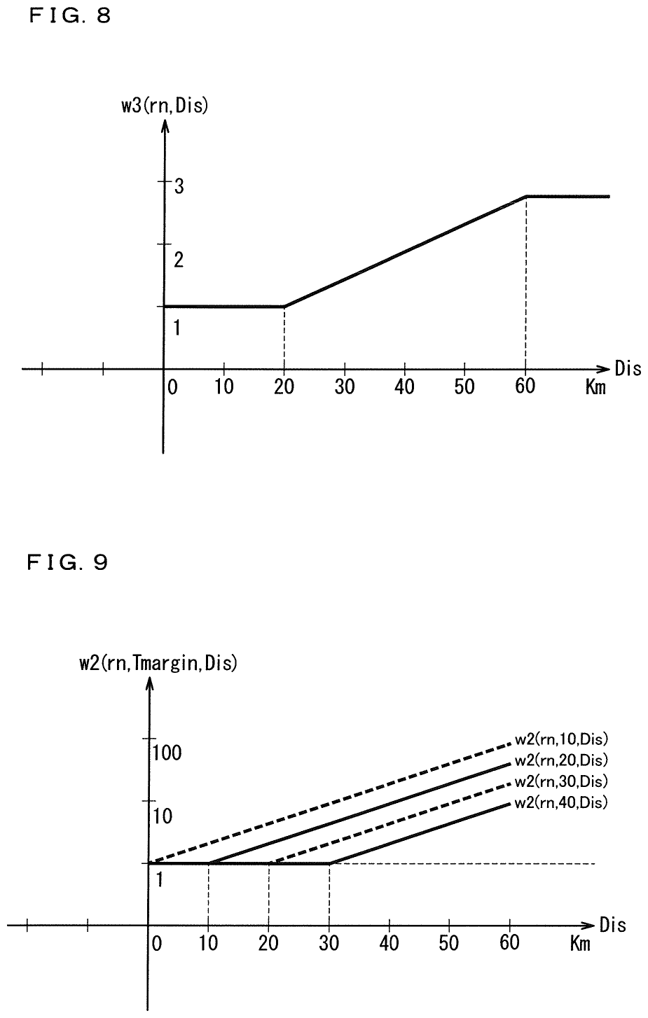

FIG. 8 is a view showing an example of the factor w3(rn) according to this third modification. In FIG. 8, to clearly show that the factor w3(rn) is a function of the road rn and a distance Dis between the road rn and the pick-up position, the factor w3(rn) is expressed as w3(rn, Dis).

In the example in FIG. 8, the factor w3(rn) is expressed by a continuous function by which, as the distance Dis increases in a range from 20 to 60 km, a value increases continuously. More specifically, if the distance Dis is less than 20 km, the factor w3(rn) takes a value of 1. If the distance Dis is from 20 to 60 km, the factor w3(rn) takes a value that increases linearly from 1 to 3 with increase in the distance Dis. If the distance Dis is equal to or greater than 60 km, the factor w3(rn) takes a value of 3.

If a speed limit on the road rn is high, an amount of time for arrival at the pick-up position from the road rn is less prone to be influenced by a distance between the road rn and the pick-up position. Thus, a rate of increase of the factor w3(rn) relative to increase in the distance Dis may be reduced. Moreover, the factor w3(rn) may be expressed by a monotonously increasing function or by a discontinuous function such as a step function, for example.

According to this third modification described above, the traveling plan preparation unit 12 performs both of increasing convenience cost of a road with a smaller margin of time on the road and reducing convenience cost of a road with greater closeness of the road to the pick-up position. This configuration makes it possible to prepare an autonomous driving traveling plan for causing the subject vehicle to travel on a road of greatest possible closeness to the pick-up position with a smaller margin of time.

According to an actual operational situation, it may be desired in an autonomous driving traveling plan that the subject vehicle will travel on the road rn far from the pick-up position. In this case, the traveling plan preparation unit 12 may reduce a value of the factor w3(rn) in response to increase in the distance Dis while changing the factor w1(rn) and the factor w2(rn) as in the second embodiment. If it is desired in an autonomous driving traveling plan that the subject vehicle will travel in a particular region or on a particular road, the traveling plan preparation unit 12 may reduce a value of the factor w3(rn) for the particular region or for the particular road.

Additionally, the traveling plan preparation unit 12 may be configured to reduce a value of the factor w3(rn) of the road rn having a high traveling record in the past. Moreover, the traveling plan preparation unit 12 may assume that a short amount of time for the subject vehicle to arrive at the pick-up position from the road m and great closeness of the road m to the pick-up position mean the same thing.

<Fourth Modification of Second Embodiment>

In FIGS. 5 and 6 of the second embodiment, the factor w2(rn) is expressed as a function of the road rn and a margin of time (amount of allowed time T_{margin}). However, this is not the only case. For example, the factor w2(rn) may be expressed as a function of the road m, the margin of time (amount of allowed time T_{margin}), and the distance Dis between the road rn and a pick-up position.

FIG. 9 is a view showing an example of the factor w2(rn) according to this fourth modification. In FIG. 9, to clearly show that the factor w2(rn) is a function of the road m, the margin of time (amount of allowed time T_{margin}), and the distance Dis, the factor w2(rn) is expressed as w2(rn, T_{margin}, Dis).

The factor w2(rn) shown in the example in FIG. 9 is a factor at each of the amounts of allowed time T_{margin} of 10 minutes, 20 minutes, 30 minutes, and 40 minutes. In this example, as the amount of allowed time T_{margin} increases as 10 minutes, 20 minutes, 30 minutes, and 40 minutes, the distance Dis at which a value of the factor w2(rn) starts to increase from 1 together with increase in the distance Dis becomes larger as 0 km, 10 km, 20 km, and 30 km.

According to this fourth modification described above, the traveling plan preparation unit 12 performs both of increasing convenience cost of a road with a smaller margin of time on the road and reducing convenience cost of a road with greater closeness of the road to the pick-up position. This configuration makes it possible to prepare an autonomous driving traveling plan for causing the subject vehicle to travel on a road of greatest possible closeness to the pick-up position with a smaller margin of time without requiring use of the factor w3(rn) described in the third modification of the second embodiment.

<Fifth Modification of Second Embodiment>

In the second embodiment, regardless of whether one road rn is included repeatedly in a traveling route, the traveling plan preparation unit 12 determines the convenience cost costA(rn) equally for this road rn. By contrast, according to this fifth modification, as one road rn is repeatedly included more frequently in a traveling route, the traveling plan preparation unit 12 reduces the convenience cost costA(rn) of this road rn. This configuration makes it possible to prepare an autonomous driving traveling plan for causing the subject vehicle to travel repeatedly on the same road as much as possible. This allows a traveling environment for autonomous driving to be limited, thereby reducing the probability of the occurrence of an unexpected situation during the autonomous driving.

<Sixth Modification of Second Embodiment>

In this sixth modification, the traffic information acquisition unit 11b acquires an autonomous driving traveling plan for an autonomous driving vehicle different from the subject vehicle from the different autonomous driving vehicle (this may also be called a “different vehicle” in the following) or from a management server, for example. Then, the traffic information acquisition unit 11b acquires at least a part of a different vehicle route as a route along which the different vehicle is scheduled to travel from the autonomous driving traveling plan for the different vehicle. At least the part of the different vehicle route may be the different vehicle route in its entirety or may be a part of the different vehicle route such as a destination of the different vehicle.

In this sixth modification, the traveling plan preparation unit 12 increases the convenience cost costA(rn) of the road rn with greater closeness of this road rn to at least a part of the different vehicle route. This sixth modification described above makes it possible to prepare an autonomous driving traveling plan for causing the subject vehicle to travel in such a manner to avoid the part of the different vehicle route as much as possible. This achieves suppression of congestion to be caused by densely located autonomous driving vehicles including the subject vehicle and the different vehicle.

If the traffic information acquisition unit 11b is configured to acquire a time when the different vehicle is to travel along the different vehicle route or a time when the different vehicle is to arrive at a destination of the different vehicle, the traveling plan preparation unit 12 may change the convenience cost costA(rn) of the road m on the basis of these times.

<Seventh Modification of Second Embodiment>

In this seventh modification, the traffic information acquisition unit 11b acquires an accident occurrence level for each road m, for each time, and for each geographical feature from a VICS (registered trademark), a traffic information center, or map information, for example. Then, in this seventh modification, the traveling plan preparation unit 12 increases the convenience cost costA(rn) of the road rn with increase in an accident occurrence level on this road m. For example, as shown by the following formula (3), not only the factor w1(rn) and the factor w2(rn) but also a weighting factor w4(rn) corresponding to an accident occurrence level on the road rn may be used for the convenience cost costA(rn) of the road rn.

$$\begin{matrix}[ Formula 3 ] & \\ COSTA = {\sum }_{rn} costA ( rn ) = {\sum }_{rn} \{ cost 1 ( rn ) \cdot r 1 ( rn ) \cdot w 2 ( rn ) \cdot w 4 ( rn ) \} & ( 3 )\end{matrix}$$

The factor w4(rn) is expressed as a function by which, in the case of the lowest accident occurrence level, the factor w4(rn) takes a value of 1, and with increase in an accident occurrence level, a value thereof increases. For example, the factor w4(rn) corresponding to an accident occurrence level during hours of getting out of school in a place near an elementary school takes a value set to 3. A function expressing the factor w4(rn) may be a continuous function or a discontinuous function. This seventh modification described above makes it possible to prepare an autonomous driving traveling plan for causing the subject vehicle to travel while avoiding a road of a high accident occurrence level (a narrow road or a road where rushing by pedestrians is assumed to occur, for example) as much as possible.

<Eighth Modification of Second Embodiment>

In this eighth modification, the traffic information acquisition unit 11b acquires JO a type of the road rn from a management server or map information, for example. In this eighth modification, if the type of the road rn is a road dedicated to autonomous driving, the traveling plan preparation unit 12 reduces the convenience cost costA(rn) of this road rn. For example, if a type of the road rn is a road dedicated to autonomous driving, the traveling plan preparation unit 12 makes the convenience cost costA(rn) of this road rn lower than the convenience cost costA(rn) of the road rn if a type of this road rn is other than a road dedicated to autonomous driving. The road dedicated to autonomous driving mentioned herein may include a lane dedicated to autonomous driving.

This eighth modification described above makes it possible to prepare an autonomous driving traveling plan for causing the subject vehicle to travel on a road dedicated to autonomous driving as much as possible. If the attribute of a road dedicated to autonomous driving includes easiness indicating to which extent traveling by autonomous driving is done easily, the traveling plan preparation unit 12 may reduce the convenience cost costA(rn) of the road rn as a road dedicated to autonomous driving with a greater degree of easiness. In this case, it is possible to prepare an autonomous driving traveling plan for causing the subject vehicle to travel on a road dedicated to autonomous driving with the greatest possible easiness.

<Ninth Modification of Second Embodiment>

In the second embodiment, a congestion level is constant with respect to a time. In this ninth modification, a congestion level is variable with respect to a future time. In this ninth modification, the traffic information acquisition unit 11b acquires an autonomous driving traveling plan for a different vehicle from a different vehicle or from a management server, and acquires a different vehicle route as a route along which the different vehicle is scheduled to travel from the autonomous driving traveling plan for the different vehicle. Then, the traffic information acquisition unit 11b acquires a congestion level variable with respect to a future time on the basis of the different vehicle route. Such prediction with respect to a future time may be made using a technique described in Japanese Patent Application Laid-Open No. 2020-34576, for example. As another example, the traffic information acquisition unit 11b may acquire a congestion level variable with respect to a future time on the basis of a history of a congestion level in the past on each road rn.

In this ninth modification, the traveling plan preparation unit 12 prepares an autonomous driving traveling plan using a congestion level variable with respect to a future time. For example, the traveling plan preparation unit 12 may prepare an autonomous driving traveling plan based on a variable congestion level using a technique such as route search of a navigation device and using a method of mathematical predictive calculation. As another example, the traveling plan preparation unit 12 may determine a scheduled time when the subject vehicle is to travel on the road m and may determine the convenience cost costA(rn) of the road m using a value of the factor w1(rn) corresponding to a congestion level corresponding to these road rn and scheduled time. This ninth modification described above makes it possible to increase the accuracy of a congestion level, thereby allowing reduction in the occurrence of a traffic jam properly.

<Tenth Modification of Second Embodiment>

In this tenth modification, the instruction information acquisition unit 11a acquires not only pick-up instruction information but also provisional pick-up instruction information from the portable terminal 54 through the communication device 52. The provisional pick-up instruction information is information similar to the pick-up instruction information, and includes a provisional pick-up time after a pick-up time and a provisional pick-up position where the subject vehicle is to be located on the provisional pick-up time.

In this tenth modification, on the basis of the provisional pick-up instruction information, a congestion level, the pick-up instruction information, and map information, the traveling plan preparation unit 12 prepares a new autonomous driving traveling plan for the subject vehicle to arrive at the provisional pick-up position on the provisional pick-up time in the absence of getting on the subject vehicle on the pick-up time at the pick-up position. For example, during the preparation of an autonomous driving traveling plan described in the second embodiment, the new autonomous driving traveling plan may be prepared by replacing pick-up instruction information (a pick-up time and a pick-up position) with provisional pick-up instruction information (a provisional pick-up time and a provisional pick-up position) and by replacing an acquisition time and an acquisition vehicle position with the pick-up time and the pick-up position in the pick-up instruction information.

According to this tenth modification described above, a new autonomous driving traveling plan is prepared in response to the absence of getting on the subject vehicle on the pick-up time at the pick-up position. Thus, even if a user fails to get on the subject vehicle on the pick-up time at the pick-up position, the user is still allowed to get on the subject vehicle on the provisional pick-up time at the provisional pick-up position.

In the absence of getting on the subject vehicle on the pick-up time at the pick-up position, the traveling plan preparation apparatus 1 may contact the portable terminal 54 of a user to see whether the pick-up time and the pick-up position are to be changed. If the traveling plan preparation apparatus 1 receives a response from the portable terminal 54 of the user to the effect that such changes are to be made, the autonomous driving controller 51 may control traveling by the subject vehicle on the basis of a new autonomous driving traveling plan. On the other hand, if the traveling plan preparation apparatus 1 receives a response from the portable terminal 54 of the user to the effect that such changes are not to be made, the autonomous driving controller 51 may keep the subject vehicle on standby at the pick-up position.

<Eleventh Modification of Second Embodiment>

In this eleventh modification, if a plan change condition defined in advance is fulfilled in a period from preparation of an autonomous driving traveling plan to arrival of the subject vehicle at a pick-up position, the traveling plan preparation unit 12 changes the autonomous driving traveling plan.

In this eleventh modification, the plan change condition is a condition to be fulfilled if a congestion level is changed. In this eleventh modification, the traveling plan preparation unit 12 changes the autonomous driving traveling plan on the basis of pick-up instruction information, a changed congestion level, a time and a vehicle position at a moment when the changed congestion level is acquired, and map information. For example, during the preparation of an autonomous driving traveling plan described in the second embodiment, the changed autonomous driving traveling plan may be prepared by replacing a congestion level with the changed congestion level and by replacing an acquisition time and an acquisition vehicle position with the time and the vehicle position at a moment when the changed congestion level is acquired.

According to this eleventh modification described above, an autonomous driving traveling plan is changed in response to change in a congestion level to achieve autonomous driving conforming to the change in a congestion level.

<Twelfth Modification of Second Embodiment>

In this twelfth modification, like in the eleventh modification of the second embodiment, the traveling plan preparation unit 12 changes an autonomous driving traveling plan if a plan change condition defined in advance is fulfilled in a period from preparation of the autonomous driving traveling plan to arrival of the subject vehicle at a pick-up position.

In this twelfth modification, the plan change condition is a condition to be fulfilled if pick-up instruction information is changed in response to transmission of new pick-up instruction information from the portable terminal 54 of a user, for example. In this twelfth modification, the traveling plan preparation unit 12 changes an autonomous driving traveling plan on the basis of the changed pick-up instruction information, a congestion level, a time and a vehicle position at a moment when the changed pick-up instruction information is acquired, and map information. For example, during the preparation of an autonomous driving traveling plan described in the second embodiment, the changed autonomous driving traveling plan may be prepared by replacing pick-up instruction information with the changed pick-up instruction information and by replacing an acquisition time and an acquisition vehicle position with the time and the vehicle position at a moment when the changed pick-up instruction information is acquired.

According to this twelfth modification described above, an autonomous driving traveling plan is changed in response to change in pick-up instruction information to achieve autonomous driving conforming to the change in pick-up instruction information.

The plan change condition is not limited to those described above. For example, the plan change condition may be a condition to be fulfilled if a distance between a road on which the subject vehicle is actually traveling at a certain time and a road scheduled in an autonomous driving traveling plan is equal to or greater than a threshold.

<Thirteenth Modification of Second Embodiment>

In this thirteenth modification, a candidate pick-up time as a time within a threshold (plus or minus 10 minutes, for example) defined in advance from a pick-up time and a candidate pick-up position as a position within a threshold (about 500 m, for example) defined in advance from a pick-up position are set. A plurality of the candidate pick-up times and a plurality of the candidate pick-up positions may be prepared. However, to simplify the description here, the description proceeds on the assumption that one candidate pick-up time and one candidate pick-up position are prepared.

In this thirteenth modification, the traveling plan preparation unit 12 determines candidate traveling cost corresponding to traveling cost on the basis of the candidate pick-up time, the candidate pick-up position, a congestion level, a time and the vehicle position at a moment when pick-up instruction information is acquired, and map information. For example, referring to the way of determining traveling cost described in the second embodiment, the candidate traveling cost may be determined by replacing a pick-up time and a pick-up position with the candidate pick-up time and the candidate pick-up position.

In this thirteenth modification, the traveling plan preparation unit 12 causes a notification device to notify the candidate pick-up time and the candidate pick-up position on the basis of result of comparison between the traveling cost and the candidate traveling cost. For example, if the candidate traveling cost is smaller than the traveling cost, the traveling plan preparation unit 12 causes the notification device to notify the candidate pick-up time and the candidate pick-up position. The notification device may be the display device 56 shown in FIG. 7 or may be a voice output device not shown in the drawings.

According to this thirteenth modification described above, if a congestion level is high on a road to which a pick-up position instructed by a user belongs and if a congestion level is not high on a road to which a candidate pick-up position within a few minutes walk from the pick-up position belongs, for example, the user can be notified of the candidate pick-up position. Referring to FIG. 4, the node n43 allowing reduction in a sum of congestion levels compared to the pick-up position D is notified as the candidate pick-up position, for example. Likewise, if a congestion level is high on a pick-up time instructed by a user on a road to which a pick-up position belongs and if a congestion level on this road is not high on a candidate pick-up time shifted from the pick-up time by a few minutes, for example, the user can be notified of the candidate pick-up time.

As a result of the foregoing, the user becomes capable of performing operation of setting the notified candidate pick-up position as a pick-up position or operation of setting the notified candidate pick-up time as a pick-up time, making it possible to reduce the occurrence of a traffic jam.

<Fourteenth Modification of Second Embodiment>

While an acquisition vehicle position is the same as a pick-up position in the second embodiment, it may differ from the pick-up position. It is assumed, for example, that during traveling through a position E by an autonomous driving vehicle scheduled for pick-up, a user gets off a different autonomous driving vehicle at the shopping plaza D or the user arrives at the shopping plaza D by different traffic means. In such cases, the position E of the autonomous driving vehicle scheduled for pick-up may be acquired as the acquisition vehicle position and the shopping plaza D may be acquired as the pick-up position.

It is also assumed that, after the subject vehicle is used by a user in arriving at the shopping plaza D, the subject vehicle is to be used by a different user. In this case, the instruction information acquisition unit 11a may temporarily store, into a memory into a memory, pick-up instruction information accepted from the user having gotten off the subject vehicle at the shopping plaza D, and may acquire the pick-up instruction information from the memory at a moment when the subject vehicle is released from use by the different user. Specifically, the traveling plan preparation unit 12 may prepare an autonomous driving traveling plan using a time when the subject vehicle is released from the use by the different user as an acquisition time and using a position where the subject vehicle is released from the use by the different user as an acquisition vehicle position. Moreover, when the subject vehicle is released from the use by the different user, the traveling plan preparation unit 12 may transmit the release to the portable terminal 54 of the user, for example.

### Third Embodiment

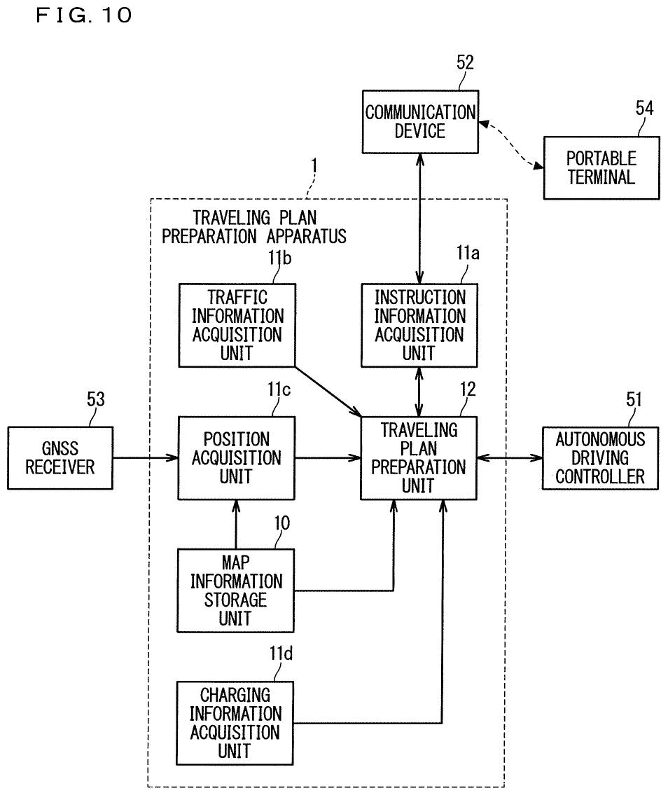

FIG. 10 is a block diagram showing the configuration of a traveling plan preparation apparatus 1 according to a third embodiment. Of constituting elements of the third embodiment, constituting elements same as or similar to those described above are given the same or similar reference signs, and different constituting elements will mainly be described.

The traveling plan preparation apparatus 1 in FIG. 10 is comparable to a configuration formed by adding a charging information acquisition unit 11d to the configuration in FIG. 2 described in the second embodiment. The charging information acquisition unit 11d is included in the concept of the acquisition unit 11 in FIG. 1.

The charging information acquisition unit 11d acquires parking fee information about a parking lot from a traffic information center or map information, for example. The parking fee information according to the third embodiment is information indicating a relationship between a parking duration and a parking fee. A parking fee may be constant or variable with respect to a parking duration.

A parking fee is variable with respect to a parking duration in various cases, and examples of such cases are as follows, for example. (1) A fee of 300 yen is charged at the time of loading and a fee of 300 yen is charged for each parking of 30 minutes from the loading. (2) A fee of 300 yen is charged at the time of loading and a fee of 300 yen is charged for each parking of 30 minutes after passage of one hour from the loading. (3) A fee is not charged at the time of loading and a fee of 300 yen is charged for each parking of 30 minutes after passage of 30 minutes from the loading. (4) If shopping is done in a shop having a tie-up with a parking lot, a fee of 300 yen is charged for each parking of 30 minutes after passage of 2 hours from the loading.

The traveling plan preparation unit 12 determines fuel cost of a traveling route and parking fee cost of a parking lot on the basis of pick-up instruction information, an acquisition time, an acquisition vehicle position, map information, and the parking fee information, as will be described later in detail.

Traveling cost according to the third embodiment includes convenience cost of a traveling route described in the second embodiment, fuel cost of the traveling route, and parking fee cost of a parking lot. The traveling cost may be cost calculated from the convenience cost of the traveling route, fuel cost of the traveling route, and the parking fee cost of the parking lot. The traveling plan preparation unit 12 prepares an autonomous driving traveling plan for the subject vehicle to arrive at a pick-up position on a pick-up time on the basis of the traveling cost.

<Operation>

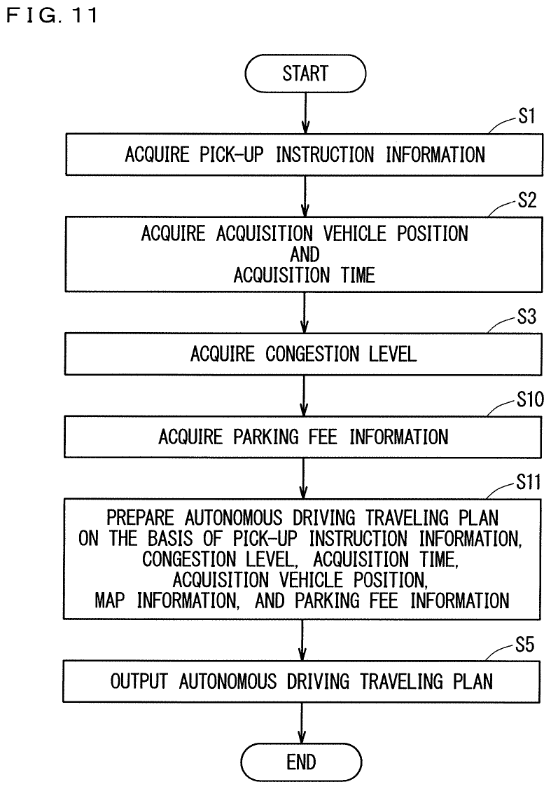

FIG. 11 is a flowchart showing operation by the traveling plan preparation apparatus 1 according to the third embodiment. The operation in FIG. 11 is comparable to operation configured by adding step S10 to the operation in FIG. 3 described in the second embodiment and by changing step S4 in FIG. 3 to step S11. For this reason, step S10 and step S11 will mainly be described below.

After step S3, the charging information acquisition unit 11d acquires parking fee information about a parking lot in step S10.

After step S10, the traveling plan preparation unit 12 prepares an autonomous driving traveling plan for the subject vehicle to arrive at a pick-up position on a pick-up time in step S11 on the basis of pick-up instruction information, a congestion level, an acquisition time and an acquisition vehicle position, map information, and the parking fee information. Then, the operation in step S5 is performed.

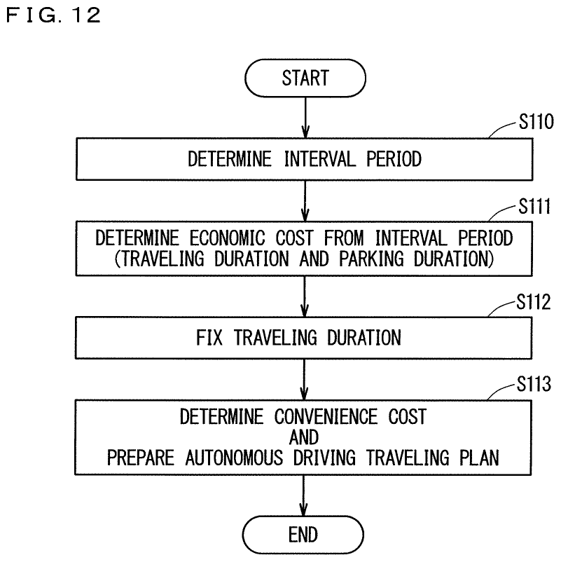

FIG. 12 is a flowchart showing the operation in step S11.

First, like in the second embodiment, the traveling plan preparation unit 12 determines a difference between the pick-up time and the acquisition time as an interval period in step S110.

In step S111, under a constrained condition that a sum of a traveling duration and a parking duration is equal to the interval period, the traveling plan preparation unit 12 comprehensively determines combinations each including a traveling duration and a parking duration. Then, the traveling plan preparation unit 12 determines fuel cost of a traveling route and parking fee cost of a parking lot for each of the combinations of the respective traveling durations and the respective parking durations, and determines a sum of the fuel cost of the traveling route and the parking fee cost of the parking lot as economic cost. The economic cost mentioned herein is expressed by the following formula (4).

$$\begin{matrix}[ Formula 4 ] & \\ COSTB = COST 2 + COST 3 = {\sum }_{rn} cost 2 ( rn ) + {\sum }_{Pm} cost 3 ( rn ) & ( 4 )\end{matrix}$$

Here, COSTB means economic cost, COST2 means fuel cost of a traveling route, and COST3 means parking fee cost of a parking lot. Furthermore, cost2(rn) means fuel cost of the road rn, Pm means a parking lot, and cost3(Pm) means a parking fee for the parking lot Pm belonging to the road rn.

In the third embodiment, the traveling plan preparation unit 12 determines the fuel cost COST2 of a traveling route on the basis of a traveling duration and a traveling speed of the subject vehicle. Furthermore, the traveling plan preparation unit 12 determines the parking fee cost COST3 for a parking lot on the basis of a parking duration and parking fee information. Then, regarding the traveling plan preparation unit 12, the traveling plan preparation unit 12 determines a sum of the fuel cost COST2 of the traveling route and the parking fee cost COST3 of the parking lot as the economic cost COSTB like in the formula (4) given above.

In step S112, the traveling plan preparation unit 12 specifies a combination of a traveling duration and a parking duration that results in the lowest economic cost COSTB, and fixes a traveling duration from the specified combination.

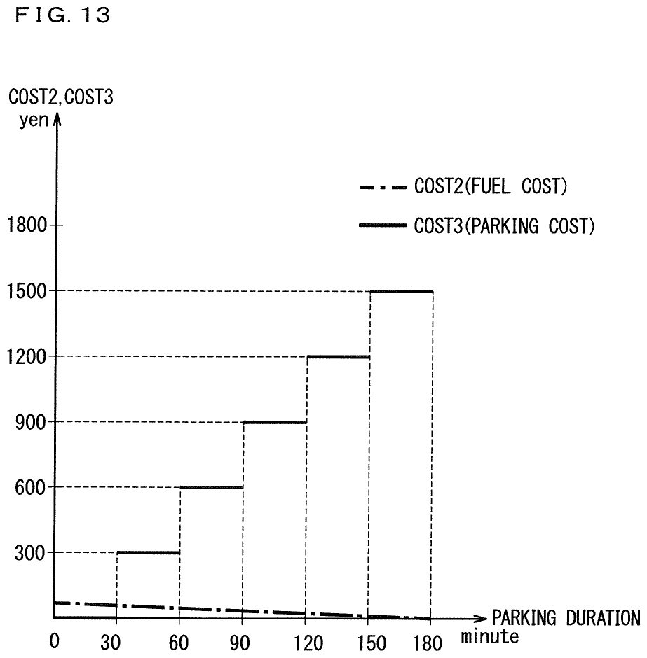

FIG. 13 is a view showing an example of the fuel cost COST2 of a traveling route and an example of the parking fee cost COST3 of a parking lot. The examples in FIG. 13 are based on the conditions that an interval period is 180 minutes, and a parking fee in the parking fee information is not charged at the time of loading and a fee of 300 yen is charged for each parking of 30 minutes after passage of 30 minutes from the loading.

As shown in FIG. 13, the fuel cost COST2 and a parking duration are negatively correlated to each other and the parking fee cost COST3 and a parking duration are positively correlated to each other. In other words, the fuel cost COST2 and a traveling duration are positively correlated to each other and the parking fee cost COST3 and a traveling duration are negatively correlated to each other. The fuel cost COST2 not only depends on a parking duration and a traveling duration but also depends on a vehicle driving system of driving the subject vehicle or a traveling speed of the subject vehicle. However, to simplify the description of an example given below, the fuel cost COST2 changes constantly with respect to a parking duration, as shown in FIG. 13.

In the examples in FIG. 13, with reduction in a parking duration, the fuel cost COST2 is increased while the parking fee cost COST3 is reduced. Thus, if a parking duration is 0 minutes, the fuel cost COST2 is the largest while the parking fee cost COST3 is the smallest. On the other hand, if a parking duration is 180 minutes, the parking fee cost COST3 is the largest while the fuel cost COST2 is the smallest.

In the examples in FIG. 13, the traveling plan preparation unit 12 determines that a combination of a parking duration of 30 minutes and a traveling duration of 150 minutes results in the smallest economic cost COSTB. Thus, in step S112, the traveling plan preparation unit 12 specifies a combination of a parking duration of 30 minutes and a traveling duration of 150 minutes, and fixes a traveling duration at 150 minutes from the specified combination.

As another example, it is assumed that a parking fee in the parking fee information is such that a fee of 300 yen is charged at the time of loading and a fee of 300 yen is charged for each parking of 30 minutes from the loading. In this case, the traveling plan preparation unit 12 determines that a combination of a parking duration of 0 minutes and a traveling duration of 180 minutes results in the smallest economic cost COSTB. Thus, in this case, the traveling plan preparation unit 12 specifies a combination of a parking duration of 0 minutes and a traveling duration of 180 minutes, and fixes a traveling duration at 180 minutes from the specified combination in step S112.

In step S113 in FIG. 12, the traveling plan preparation unit 12 determines convenience cost of the traveling route on the basis of a congestion level on a road, the fixed traveling duration, a distance between an acquisition vehicle position and the road, and a distance between the road and a pick-up position. For example, referring to the way of determining convenience cost of a traveling route described in the second embodiment, convenience cost of a traveling route according to the third embodiment may be determined by replacing the interval period with the fixed traveling duration described above. Then, the traveling plan preparation unit 12 performs a step of preparing an autonomous driving traveling plan for the subject vehicle to arrive at a pick-up position on a pick-up time on the basis of the determined convenience cost of the traveling route. Then, the operation in FIG. 12 is finished.

<Conclusion of Third Embodiment>

The traveling plan preparation apparatus 1 according to the second embodiment described above prepares an autonomous driving traveling plan for the subject vehicle to arrive at a pick-up position on a pick-up time on the basis of traveling cost including convenience cost of a traveling route, fuel cost of the traveling route, and parking fee cost of a parking lot. This configuration makes it possible to prepare an appropriate autonomous driving traveling plan in terms of fuel and a parking fee while reducing the occurrence of a traffic jam.

<First Modification of Third Embodiment>

In this first modification, the instruction information acquisition unit 11a acquires a parking fee for which payment is considered to be permissible by a user as a permissible parking fee from the portable terminal 54 through the communication device 52. In this first modification, the traveling plan preparation unit 12 prepares an autonomous driving traveling plan for the subject vehicle to arrive at a pick-up position on a pick-up time on the basis of pick-up instruction information, a congestion level, an acquisition time, an acquisition vehicle position, map information, parking fee information, and the permissible parking fee. For example, the traveling plan preparation unit 12 may use cost obtained by subtracting the permissible parking fee from parking fee cost as parking fee cost according to this first modification. With the permissible parking fee of 300 yen in the case of FIG. 13, for example, this configuration allows the traveling plan preparation unit 12 to determine that a combination of a traveling duration of 60 minutes and a parking duration of 120 minutes results in the lowest economic cost COSTB.

<Second Modification of Third Embodiment>

In this second modification, the charging information acquisition unit 11d acquires toll information about each road from a traffic information center or map information, for example. The toll information is information indicating a fee to be charged when the subject vehicle travels on a road while doing autonomous driving. The toll information is defined in such a manner that, with increase in a duration of doing autonomous driving and increase in a distance of the autonomous driving, a fee to be charged is increased, for example. The toll information may differ between roads.

In this second modification, the traveling plan preparation unit 12 determines toll cost of a traveling route on the basis of pick-up instruction information, a time and a vehicle position at a moment when the pick-up instruction information is acquired, map information, and the toll information. Then, the traveling plan preparation unit 12 prepares an autonomous driving traveling plan for the subject vehicle to arrive at a pick-up position on a pick-up time on the basis of traveling cost including convenience cost of the traveling route and the toll cost.

For example, the traveling plan preparation unit 12 may calculate a traveling duration on the assumption that all roads are roads subjected to charging of maximum fees, and then may prepare an autonomous driving traveling plan including as many roads of low charged fees as possible. As another example, the traveling plan preparation unit 12 may prepare an autonomous driving traveling plan by using traveling cost according to this second modification obtained by adding the toll cost to traveling cost calculated from the formula (1) given above.

In the foregoing description, traveling cost includes convenience cost of a traveling route and toll cost. However, this is not the only case. For example, traveling cost may include convenience cost of a traveling route, fuel cost of the traveling route, parking fee cost of a parking lot, and toll cost.

<Third Modification of Third Embodiment>

In the third embodiment, the traveling plan preparation unit 12 fixes a traveling duration from economic cost (step S112 in FIG. 13), and then prepares an autonomous driving traveling plan on the basis of convenience cost in which the determined traveling duration is reflected (step S113 in FIG. 13). However, this is not the only case. For example, the traveling plan preparation unit 12 may determine the convenience cost COSTA and the economic cost COSTB while changing a traveling duration as a parameter. Then, the traveling plan preparation unit 12 may obtain a sum of a fee calculated by converting the convenience cost COSTA according to a rule defined in advance and the economic cost COSTB, determine the sum as the traveling cost COST as shown by the following formula (5), and determine an autonomous driving traveling plan on the basis of the determined traveling cost COST. Here, Weco means a factor used in converting convenience cost to a fee.

[Formula 5]

COST=Weco·COSTA+COSTB (5)

<Fourth Modification of Third Embodiment>

In this fourth modification, a parking lot in parking fee information includes a priority parking lot that is a parking lot giving priority to the subject vehicle. A parking lot giving priority to the subject vehicle includes a parking lot dedicated to the subject vehicle in which the subject vehicle is allowed to park at a low fee or for free, and an individual parking lot owned by a user of the subject vehicle, for example.

In this fourth modification, the traveling plan preparation unit 12 makes parking fee cost of the priority parking lot lower than parking fee costs of other parking lots. This configuration makes it possible to prepare an autonomous driving traveling plan for causing the subject vehicle to park in a priority parking lot as much as possible.

### Fourth Embodiment

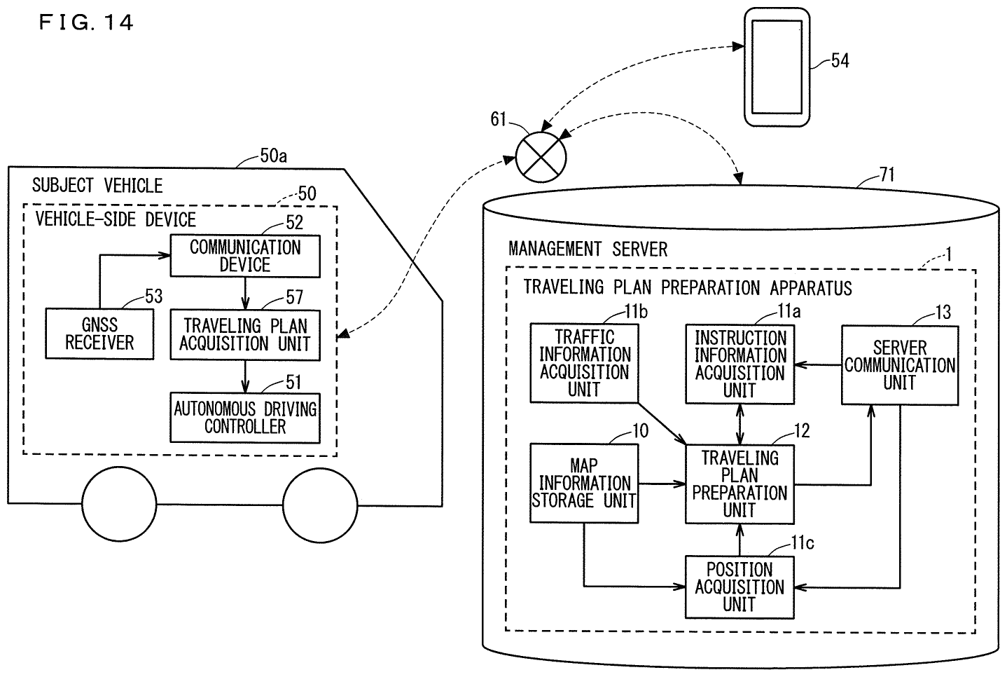

FIG. 14 is a block diagram showing the configuration of a traveling plan preparation apparatus 1 according to a fourth embodiment. Of constituting elements of the fourth embodiment, constituting elements same as or similar to those described above are given the same or similar reference signs, and different constituting elements will mainly be described.

In the first embodiment, the traveling plan preparation apparatus 1 is installed on a subject vehicle 50a. In the fourth embodiment, both the acquisition unit 11 and the traveling plan preparation unit 12 of the traveling plan preparation apparatus 1 described in the first embodiment are provided to a management server 71. A portable terminal 54 in FIG. 14 is the same as the portable terminal 54 in FIG. 2.

The subject vehicle 50a in FIG. 14 is provided with a vehicle-side device 50. The vehicle-side device 50 includes an autonomous driving controller 51, a communication device 52, a GNSS receiver 53, and a traveling plan acquisition unit 57.

The GNSS receiver 53 is the same as the GNSS receiver 53 in FIG. 2. The communication device 52 transmits a vehicle position of the subject vehicle 50a measured by the GNSS receiver 53 to the management server 71. The communication device 52 receives an autonomous driving traveling plan prepared by the management server 71 from the management server 71. The traveling plan acquisition unit 57 acquires the autonomous driving traveling plan received by the communication device 52. The autonomous driving controller 51 controls traveling by the subject vehicle 50a on the basis of the autonomous driving traveling plan acquired by the traveling plan acquisition unit 57.

The traveling plan preparation apparatus 1 provided in the management server 71 in FIG. 14 includes a map information storage unit 10, an instruction information acquisition unit 11a, a traffic information acquisition unit 11b, a position acquisition unit 11c, the traveling plan preparation unit 12, and a server communication unit 13. The map information storage unit 10, the instruction information acquisition unit 11a, the traffic information acquisition unit 11b, the position acquisition unit 11c, and the traveling plan preparation unit 12 in FIG. 14 are substantially the same as the map information storage unit 10, the instruction information acquisition unit 11a, the traffic information acquisition unit 11b, the position acquisition unit 11c, and the traveling plan preparation unit 12 in FIG. 2 respectively. For this reason, the instruction information acquisition unit 11a, the traffic information acquisition unit 11b, and the position acquisition unit 11c in FIG. 14 are included in the concept of the acquisition unit 11 in FIG. 1.

The server communication unit 13 receives the vehicle position of the subject vehicle 50a from the vehicle-side device 50 through a communication network 61, and receives pick-up instruction information from the portable terminal 54 through the communication network 61. The server communication unit 13 transmits the autonomous driving traveling plan prepared by the traveling plan preparation unit 12 to the vehicle-side device 50.

The instruction information acquisition unit 11a acquires the pick-up instruction information received by the server communication unit 13. The position acquisition unit lie acquires the vehicle position of the subject vehicle 50a received by the server communication unit 13.

<Conclusion of Fourth Embodiment>

In the fourth embodiment described above, both the acquisition unit 11 and the traveling plan preparation unit 12 of the traveling plan preparation apparatus 1 described in the first embodiment are provided in the management server 71. This configuration achieves effects comparable to those described in the first embodiment, etc. In the foregoing description, both the acquisition unit 11 and the traveling plan preparation unit 12 of the traveling plan preparation apparatus 1 are provided in the management server 71. However, this is not the only case. For example, a part of the acquisition unit 11 and the traveling plan preparation unit 12 of the traveling plan preparation apparatus 1 may be provided in the management server 71 and the other may be provided in the vehicle-side device 50.

<First Modification of Fourth Embodiment>

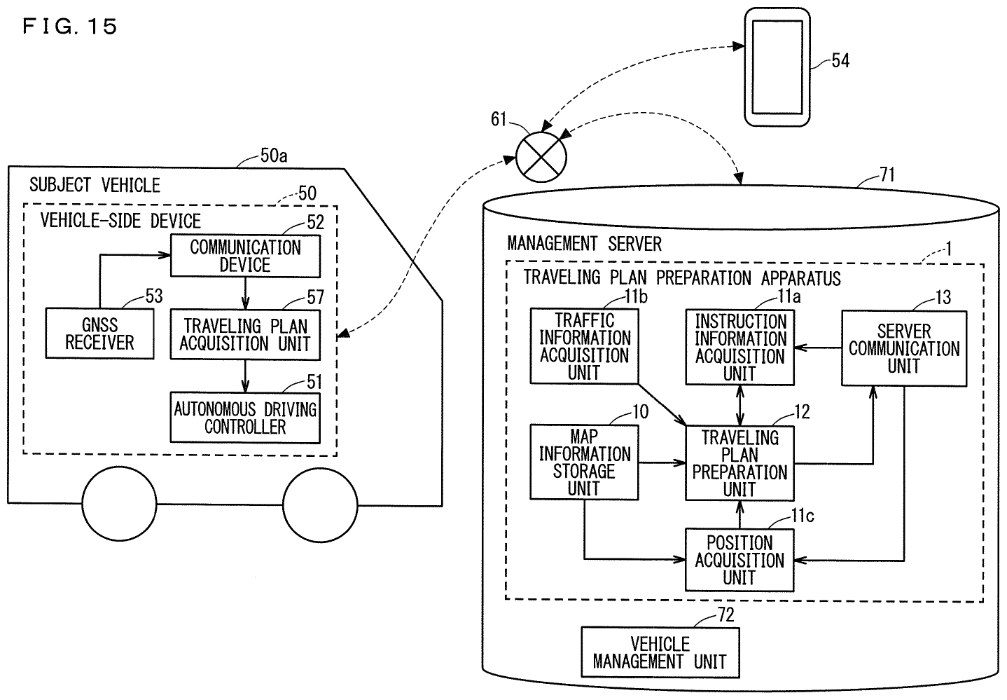

FIG. 15 is a block diagram showing the configuration of a traveling plan preparation apparatus 1 according to this first modification.

The traveling plan preparation apparatus 1 in FIG. 15 not only prepares an autonomous driving traveling plan for the subject vehicle but also prepares an autonomous driving traveling plan for a different vehicle under contract with the management server 71. In this first modification, an autonomous driving traveling plan for the different vehicle is prepared by applying the different vehicle to the subject vehicle targeted for the preparation of an autonomous driving traveling plan for the subject vehicle described so far.

The autonomous driving traveling plans for the subject vehicle and for the different vehicle prepared by the traveling plan preparation apparatus 1 are transmitted to the subject vehicle and to the different vehicle or a vehicle management unit 72 in FIG. 15. While the vehicle management unit 72 is provided outside the traveling plan preparation apparatus 1 in FIG. 15, it may be provided in the traveling plan preparation apparatus 1.

Like in the ninth modification of the second embodiment, the traffic information acquisition unit 11b according to this first modification acquires a congestion level variable with respect to a future time on the basis of routes along which the subject vehicle and the different vehicle are scheduled to travel. Then, the server communication unit 13 of the management server 71 transmits the congestion level variable with respect to a future time acquired by the traffic information acquisition unit 11b to the subject vehicle and to the different vehicle. This configuration allows use of a congestion level variable with respect to a future time for the subject vehicle and the different vehicle.

<Second Modification of Fourth Embodiment>

In the first modification of the fourth embodiment, the server communication unit 13 of the management server 71 transmits a congestion level variable with respect to a future time to the subject vehicle and to the different vehicle. By contrast, in this second modification, the traveling plan preparation unit 12 of the traveling plan preparation apparatus 1 prepares traveling plans for the subject vehicle and for the different vehicle using a variable congestion level acquired by the traffic information acquisition unit 11b. Then, the server communication unit 13 of the management server 71 transmits the autonomous driving traveling plans for the subject vehicle and for the different vehicle prepared by the traveling plan preparation unit 12 to the subject vehicle and to the different vehicle. Like the ninth modification of the second embodiment, this configuration makes it possible to increase the accuracy of a congestion level, thereby allowing reduction in the occurrence of a traffic jam properly.

The tenth modification of the second embodiment (the configuration using provisional pick-up instruction information) may be applied to this second modification. In a resultant configuration, even if a user fails to get on the subject vehicle or the different vehicle on a pick-up time at a pick-up position, the user is still allowed to get on the subject vehicle or the different vehicle on a provisional pick-up time at a provisional pick-up position.

The fourth modification of the third embodiment (the configuration where a parking lot includes a priority parking lot) may be applied to this second modification. In a resultant configuration, if reservations can be made for parking of the subject vehicle and for the different vehicle in their priority parking lots, autonomous driving traveling plans for the subject vehicle and for the different vehicle can be prepared after checking reservation statuses of the priority parking lots for the subject vehicle and for the different vehicle.

<Third Modification of Fourth Embodiment>

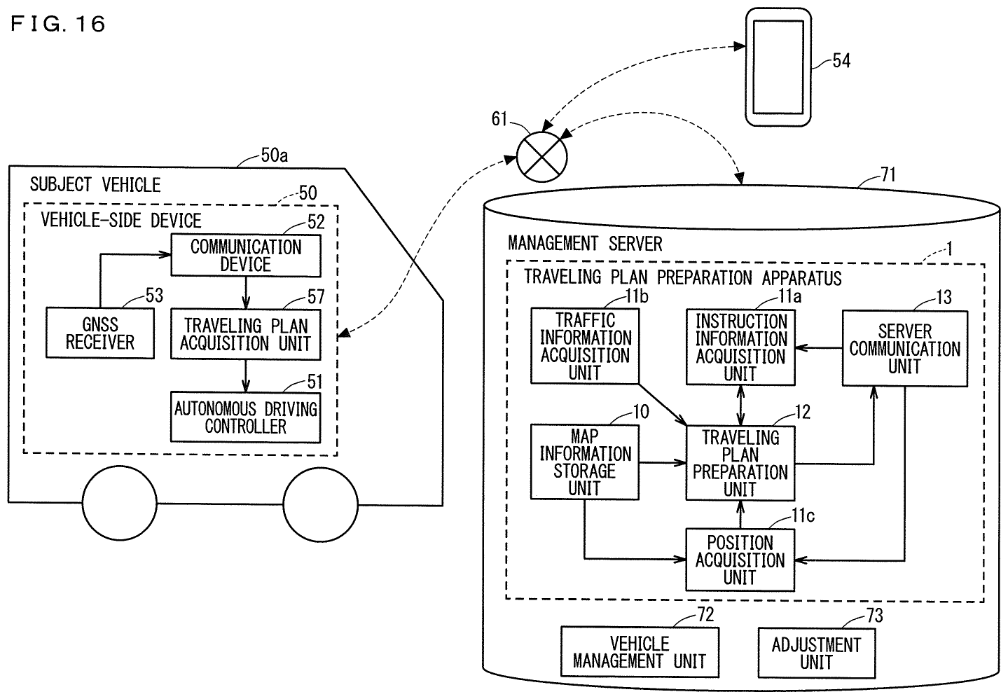

FIG. 16 is a block diagram showing the configuration of a traveling plan preparation apparatus 1 according to this third modification. On the basis of autonomous driving traveling plans for the subject vehicle and for the different vehicle managed by the vehicle management unit 72, an adjustment unit 73 in FIG. 16 adjusts the autonomous driving traveling plans for the subject vehicle and for the different vehicle. While the adjustment unit 73 is provided outside the traveling plan preparation apparatus 1 in FIG. 16, it may be provided in the traveling plan preparation apparatus 1.

The sixth modification of the second embodiment (the configuration of giving consideration to an autonomous driving traveling plan for the different vehicle in an autonomous driving traveling plan for the subject vehicle) and the eighth modification of the second embodiment (the configuration of giving consideration to a road dedicated to autonomous driving) may be applied to this third modification. A resultant configuration allows autonomous driving traveling plans for the subject vehicle and for the different vehicle to be adjusted in such a manner as to avoid congestion on the road dedicated to autonomous driving.

<Other Modifications>

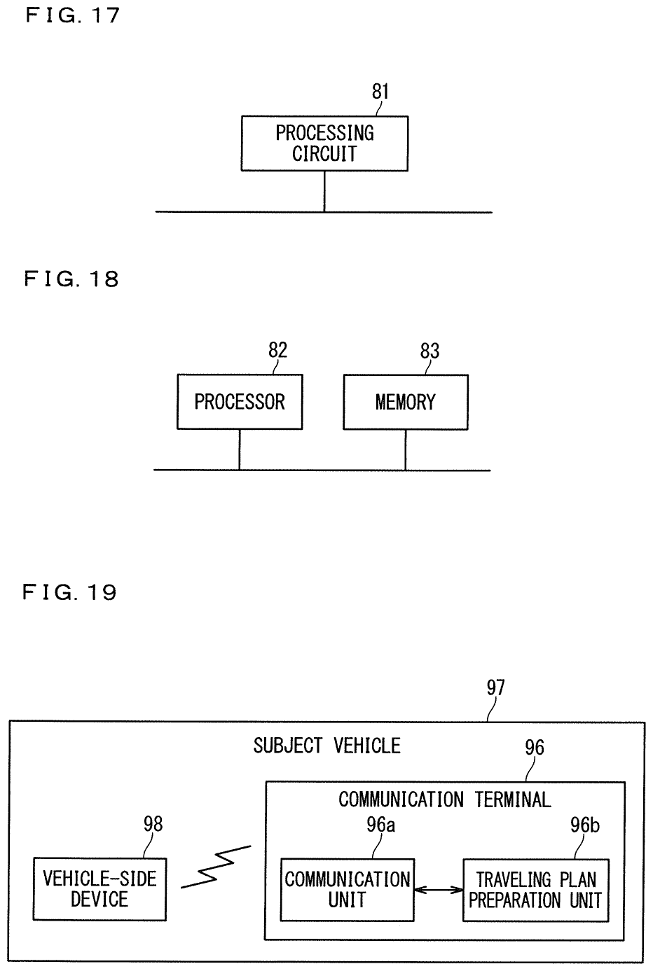

The acquisition unit 11 and the traveling plan preparation unit 12 in FIG. 1 described above will be called “the units including the acquisition unit 11.” The units including the acquisition unit 11 are realized by a processing circuit 81 shown in FIG. 17. Specifically, the processing circuit 81 includes: the acquisition unit 11 that acquires pick-up instruction information, a congestion level on each road classified in advance, and a vehicle position as the position of an autonomous driving vehicle; and the traveling plan preparation unit 12 that determines traveling cost including convenience cost of a traveling route including the road for the autonomous driving vehicle on the basis of the pick-up instruction information, the congestion level, a time and the vehicle position at a moment when the pick-up instruction information is acquired, and map information, prepares an autonomous driving traveling plan for the autonomous driving vehicle to arrive at a pick-up position on a pick-up time on the basis of the traveling cost, increases the convenience cost of the road as the congestion level on the road becomes higher, and performs at least one of a process of increasing the convenience cost of the road with a smaller margin of time for the autonomous driving vehicle to arrive at the pick-up position from the road by the pick-up time and a process of reducing the convenience cost of the road with greater closeness of the road to the pick-up position. The processing circuit 81 may be dedicated hardware, or may be a processor to execute a program stored in a memory. The processor may be a central processing unit, a processing device, an arithmetic device, a microprocessor, a microcomputer, or a digital signal processor (DSP), for example.

If the processing circuit 81 is dedicated hardware, the processing circuit 81 corresponds to a single circuit, a complex circuit, a programmed processor, a parallel-programmed processor, an application specific integrated circuit (ASIC), a field-programmable gate array (FPGA), or a combination thereof, for example. The function of each unit such as the function of each of the units including the acquisition unit 11 may be realized by distributed circuits from the processing circuit. Alternatively, the functions of all the units may be realized together in one processing circuit.

If the processing circuit 81 is a processor, the functions of the units including the acquisition unit 11 are realized by combination with a kind of software. Such a kind of software corresponds to software, firmware, or software and firmware, for example. Such a kind of software is described as a program and stored into a memory. As shown in FIG. 18, a processor 82 applied to the processing circuit 81 reads a program stored in a memory 83 and executes the read program, thereby realizing the function of each unit. Specifically, the traveling plan preparation apparatus 1 includes the memory 83 for storing the program that eventually results in implementations of steps when the program is executed by the processing circuit 81, and these steps include: a step of acquiring pick-up instruction information, a congestion level on each road classified in advance, and a vehicle position as the position of an autonomous driving vehicle; and a step of determining traveling cost including convenience cost of a traveling route including the road for the autonomous driving vehicle on the basis of the pick-up instruction information, the congestion level, a time and the vehicle position at a moment when the pick-up instruction information is acquired, and map information, preparing an autonomous driving traveling plan for the autonomous driving vehicle to arrive at a pick-up position on a pick-up time on the basis of the traveling cost, increasing the convenience cost of the road as the congestion level on the road becomes higher, and performing at least one of a process of increasing the convenience cost of the road with a smaller margin of time for the autonomous driving vehicle to arrive at the pick-up position from the road by the pick-up time and a process of reducing the convenience cost of the road with greater closeness of the road to the pick-up position. In other words, this program can be said to be a program for causing a computer to implement the procedures or methods of the units including the acquisition unit 11. Here, the memory 83 can be a nonvolatile or volatile semiconductor memory such as a random access memory (RAM), a read only memory (ROM), a flash memory, an erasable programmable read only memory (EPROM) or an electrically erasable programmable read only memory (EEPROM), a hard disk drive (HDD), a magnetic disk, a flexible disk, an optical disk, a compact disk, a minidisk, a digital versatile disc (DVD), drivers thereof, or any type of storage medium to be used in the future, for example.

In the configuration described above, the respective functions of the units including the acquisition unit 11 are realized by one of hardware and a kind of software. However, this is not the limited configuration. In one configuration, some of the units including the acquisition unit 11 may be realized by dedicated hardware and a different one of the units may be realized by a kind of software. For example, the function of the acquisition unit 11 may be realized by the processing circuit 81 as dedicated hardware, by an interface, by a receiver, etc., and the functions of the other units may be realized by causing the processing circuit 81 as the processor 82 to read the program stored in the memory 83 and to execute the read program.

As described above, the processing circuit 81 is available for realizing each of the above-described functions using hardware, a kind of software, or a combination thereof.

The traveling plan preparation apparatus 1 described above is also applicable to a traveling plan preparation system constructed as a system by combining a vehicle-side device including a portable navigation device (PND), an autonomous driving controller, etc., a communication terminal including a portable terminal such as a cell phone, a smartphone, or a tablet, an application function installed on at least one of the vehicle-side device and the communication terminal, and a server appropriately. In this case, all the functions or all the constituting element of the traveling plan preparation apparatus 1 described above may be arranged in a distributed manner in each device forming the system or may be arranged in a concentrated manner in any of the devices.

FIG. 19 is a block diagram showing the configuration of a communication terminal 96 according to this modification. The communication terminal 96 in FIG. 19 includes a communication unit 96a and a traveling plan preparation unit 96b, and is configured to form radio communication with a vehicle-side device 98 of a subject vehicle 97 such as an autonomous driving controller. The communication terminal 96 may be a portable terminal such as a cell phone, a smartphone, or a tablet carried by a driver of the subject vehicle 97, for example.

The communication unit 96a as an acquisition unit forms radio communication with the vehicle-side device 98 to receive pick-up instruction information, a congestion level, and a vehicle position of the subject vehicle 97 acquired by the vehicle-side device 98.

A program stored in a memory not shown in the drawings of the communication terminal 96 is executed by a processor not shown in the drawings of the communication terminal 96, for example, thereby causing the traveling plan preparation unit 96b to fulfill a function comparable to that of the traveling plan preparation unit 12 in FIG. 1. Specifically, the traveling plan preparation unit 96b determines traveling cost including convenience cost on the basis of the pick-up instruction information, the congestion level, and the vehicle position received by the communication unit 96a, and prepares an autonomous driving traveling plan on the basis of the traveling cost. In doing so, the traveling plan preparation unit 96b increases the convenience cost of a road as the congestion level on the road becomes higher, and performs at least one of a process of increasing the convenience cost of the road with a smaller margin of time for an autonomous driving vehicle to arrive at a pick-up position from the road by a pick-up time and a process of reducing the convenience cost of the road with greater closeness of the road to the pick-up position.

Then, the communication unit 96a transmits the autonomous driving traveling plan prepared by the traveling plan preparation unit 96b to the vehicle-side device 98. The communication terminal 96 having this configuration achieves effects comparable to those achieved by the traveling plan preparation apparatus 1 described in the first embodiment.

The embodiments and the modifications can be combined freely or each of the embodiments and each of the modifications can be modified or omitted, if appropriate.

The foregoing description is in all aspects illustrative and not restrictive. It is therefore understood that numerous modifications not shown can be devised.

### EXPLANATION OF REFERENCE SIGNS

1 Traveling plan preparation apparatus
11 Acquisition unit
12 Traveling plan preparation unit
50a, 97 Subject vehicle
71 Management server

1. A traveling plan preparation apparatus that prepares an autonomous driving traveling plan for an autonomous driving vehicle configured to do autonomous driving using map information and instructs the autonomous driving vehicle to follow the autonomous driving traveling plan, comprising:
acquisition circuitry that acquires pick-up instruction information including a pick-up time and a pick-up position where the autonomous driving vehicle is to be located on the pick-up time, a congestion level on each of roads classified in advance, and a vehicle position as the position of the autonomous driving vehicle; and
traveling plan preparation circuitry that determines traveling cost including convenience cost of a traveling route including the road for the autonomous driving vehicle on the basis of the pick-up instruction information, the congestion level, a time and the vehicle position at a moment when the pick-up instruction information is acquired, and the map information, and prepares the autonomous driving traveling plan for the autonomous driving vehicle to arrive at the pick-up position on the pick-up time on the basis of the traveling cost, wherein
the traveling plan preparation circuitry performs at least one of
a process of increasing the convenience cost of the road as the congestion level on the road becomes higher, and increasing the convenience cost of the road with a smaller margin of time for the autonomous driving vehicle to arrive at the pick-up position from the road by the pick-up time, and
a process of increasing the convenience cost of the road as the congestion level on the road becomes higher, and reducing the convenience cost of the road with greater closeness of the road to the pick-up position.

2. The traveling plan preparation apparatus according to claim 1, wherein
the acquisition circuitry acquires the pick-up instruction information when a user gets off the autonomous driving vehicle, and
the traveling plan preparation circuitry prepares the autonomous driving traveling plan for the autonomous driving vehicle to travel through a position farther from the pick-up position than the vehicle position at a moment when the pick-up instruction information is acquired in a period from the time at a moment when the pick-up instruction information is acquired to the pick-up time.

3. The traveling plan preparation apparatus according to claim 1, wherein
the traveling plan preparation circuitry performs both of increasing the convenience cost of the road with a smaller margin of time for the autonomous driving vehicle to arrive at the pick-up position from the road by the pick-up time and reducing the convenience cost of the road with greater closeness of the road to the pick-up position.

4. The traveling plan preparation apparatus according to claim 1, wherein
the traveling plan preparation circuitry reduces the convenience cost of one of the roads as the one road is repeatedly included more frequently in the traveling route.

5. The traveling plan preparation apparatus according to claim 1, wherein
the acquisition circuitry further acquires at least a part of a different vehicle route as a route along which a different autonomous driving vehicle is scheduled to travel, and
the traveling plan preparation circuitry increases the convenience cost of the road with greater closeness of the road to at least the part of the different vehicle route.

6. The traveling plan preparation apparatus according to claim 1, wherein
the acquisition circuitry further acquires an accident occurrence level for each of the roads, and
the traveling plan preparation circuitry increases the convenience cost of the road with increase in the accident occurrence level on the road.

7. The traveling plan preparation apparatus according to claim 1, wherein
the acquisition circuitry further acquires a type of the road, and
the traveling plan preparation circuitry reduces the convenience cost of the road if the type of the road is a road dedicated to autonomous driving.

8. The traveling plan preparation apparatus according to claim 1, wherein
the congestion level is variable with respect to a future time.

9. The traveling plan preparation apparatus according to claim 8, wherein
the acquisition circuitry further acquires a different vehicle route as a route along which a different autonomous driving vehicle is scheduled to travel, and acquires the congestion level on the basis of the different vehicle route.

10. The traveling plan preparation apparatus according to claim 1, wherein
the acquisition circuitry further acquires parking fee information about a parking lot,
the traveling plan preparation circuitry determines fuel cost of the traveling route and parking fee cost of the parking lot on the basis of the pick-up instruction information, the time and the vehicle position at a moment when the pick-up instruction information is acquired, the map information, and the parking fee information, and
the traveling cost further includes the fuel cost and the parking fee cost.

11. The traveling plan preparation apparatus according to claim 1, wherein
the acquisition circuitry further acquires toll information about each of the roads indicating a fee to be charged when the autonomous driving vehicle travels while doing the autonomous driving,
the traveling plan preparation circuitry determines toll cost of the traveling route on the basis of the pick-up instruction information, the time and the vehicle position at a moment when the pick-up instruction information is acquired, the map information, and the toll information, and
the traveling cost further includes the toll cost.

12. The traveling plan preparation apparatus according to claim 10, wherein
the parking lot includes a priority parking lot that is a parking lot giving priority to the autonomous driving vehicle, and
the traveling plan preparation circuitry reduces the parking fee cost of the priority parking lot.

13. The traveling plan preparation apparatus according to claim 1, wherein
the acquisition circuitry further acquires provisional pick-up instruction information including a provisional pick-up time after the pick-up time and a provisional pick-up position where the autonomous driving vehicle is to be located on the provisional pick-up time, and
the traveling plan preparation circuitry newly prepares the autonomous driving traveling plan for the autonomous driving vehicle to arrive at the provisional pick-up position on the provisional pick-up time in the absence of getting on the autonomous driving vehicle on the pick-up time at the pick-up position on the basis of the provisional pick-up instruction information, the congestion level, the pick-up instruction information, and the map information.

14. The traveling plan preparation apparatus according to claim 1, wherein
if a plan change condition defined in advance is fulfilled in a period from preparation of the autonomous driving traveling plan to arrival of the autonomous driving vehicle at the pick-up position, the traveling plan preparation circuitry changes the autonomous driving traveling plan.

15. The traveling plan preparation apparatus according to claim 14, wherein
the plan change condition includes changing the congestion level, and
the traveling plan preparation circuitry changes the autonomous driving traveling plan on the basis of the pick-up instruction information, the changed congestion level, a time and the vehicle position at a moment when the changed congestion level is acquired, and the map information.

16. The traveling plan preparation apparatus according to claim 14, wherein
the plan change condition includes changing the pick-up instruction information, and
the traveling plan preparation circuitry changes the autonomous driving traveling plan on the basis of the changed pick-up instruction information, the congestion level, a time and the vehicle position at a moment when the changed pick-up instruction information is acquired, and the map information.

17. The traveling plan preparation apparatus according to claim 1, wherein
the traveling plan preparation circuitry determines candidate traveling cost corresponding to the traveling cost on the basis of a candidate pick-up time within a threshold defined in advance from the pick-up time, a candidate pick-up position within a threshold defined in advance from the pick-up position, the congestion level, the time and the vehicle position at a moment when the pick-up instruction information is acquired, and the map information, and causes a notification device to notify the candidate pick-up time and the candidate pick-up position on the basis of result of comparison between the traveling cost and the candidate traveling cost.

18. The traveling plan preparation apparatus according to claim 1, wherein
at least a part of the acquisition circuitry and the traveling plan preparation circuitry is provided in a management server.

19. The traveling plan preparation apparatus according to claim 1, wherein
an autonomous driving traveling plan for a different autonomous driving vehicle is prepared by applying the different autonomous driving vehicle to the autonomous driving vehicle targeted for preparation of the autonomous driving traveling plan for the autonomous driving vehicle.

20. A traveling plan preparation method of preparing an autonomous driving traveling plan for an autonomous driving vehicle configured to do autonomous driving using map information and instructing the autonomous driving vehicle to follow the autonomous driving traveling plan, comprising:
acquiring pick-up instruction information including a pick-up time and a pick-up position where the autonomous driving vehicle is to be located on the pick-up time, a congestion level on each of roads classified in advance, and a vehicle position as the position of the autonomous driving vehicle;
determining traveling cost including convenience cost of a traveling route including the road for the autonomous driving vehicle on the basis of the pick-up instruction information, the congestion level, a time and the vehicle position at a moment when the pick-up instruction information is acquired, and the map information, and preparing the autonomous driving traveling plan for the autonomous driving vehicle to arrive at the pick-up position on the pick-up time on the basis of the traveling cost;
performing, during preparation of the autonomous driving traveling plan, at least one of
a process of increasing the convenience cost of the road as the congestion level on the road becomes higher; and increasing the convenience cost of the road with a smaller margin of time for the autonomous driving vehicle to arrive at the pick-up position from the road by the pick-up time, and
a process of increasing the convenience cost of the road as the congestion level on the road becomes higher, and reducing the convenience cost of the road with greater closeness of the road to the pick-up position during preparation of the autonomous driving traveling plan.
